(19) United States
(12) Patent Application Publication
(10) Pub. No.: US 2022/0264599 A1
(43) Pub. Date: Aug. 18, 2022

(54) Multi-TTI Scheduling DCI Design

(71) Applicant: Telefonaktiebolaget LM Ericsson (publ), Stockholm (SE)

(72) Inventors: Reem Karaki, Aachen (DE); Stephen Grant, Pleasanton, CA (US); Johan Rune, Lidingö (SE); Stefan Parkvall, Bromma (SE); Sorour Falahati, Stockholm (SE)

(21) Appl. No.: 17/622,120

(22) PCT Filed: Jun. 26, 2020
(86) PCT No.: PCT/EP2020/068036

§ 371 Date: Dec. 22, 2021

Related U.S. Application Data
(60) Provisional application No. 62/868,385, filed on Jun. 28, 2019.

(51) Int. Cl. H04W 72/12; H04W 72/04; H04W 74/08

(52) U.S. Cl. CPC H04W 72/1263; H04W 74/0866; H04W 74/0816; H04W 72/0446

(57) ABSTRACT

In one aspect, a network node is configured for multi-interval scheduling downlink or uplink transmissions to or from a wireless device. The network node sends (702), to the wireless device, configuration information indicating one or both of a maximum number of scheduling intervals that can be scheduled with a single scheduling message and a time-domain resource allocation data structure to be used when multi-interval scheduling is in use. Alternatively, the network node schedules (802) one or more downlink or uplink transmissions to or from the wireless communication device, using a single scheduling message scheduling a transmission in each of multiple scheduling intervals. The number of scheduled intervals is indicated in the scheduling message by a dedicated field in or by a time resource assignment indication that implicitly or explicitly indicates the number of scheduled intervals.

### TECHNICAL FIELD

The present disclosure generally relates to the field of wireless network communications, and more particularly, to a network node that multi-interval scheduling downlink or uplink transmissions to or from a wireless communication device.

### BACKGROUND

The New Radio (NR) standard developed by members of the 3^{rd}-Generation Partnership Project (3GPP) is designed to provide service for multiple scenarios, such as enhanced mobile broadband (eMBB), ultra-reliable and low latency communication (URLLC), and machine type communication (MTC). Each of these services has different technical requirements. For example, the general requirement for eMBB is a high data rate with moderate latency and moderate coverage, while URLLC service requires a low latency and high reliability transmission, but perhaps for moderate data rates.

One of the solutions for low latency data transmission is shorter transmission time intervals (TTI). In NR, in addition to transmission in a slot, a mini-slot transmission is also allowed, to reduce latency. A mini-slot may consist of any number of 1 to 14 orthogonal frequency-division multiplexing (OFDM) symbols. It should be noted that the concepts of slot and mini-slot are not specific to a specific service, meaning that a mini-slot may be used for either eMBB, URLLC, or other services.

### Resource Blocks

FIG. 1 shows an example of radio resources in NR. In Rel-15 NR, a wireless device (user equipment, or UE) can be configured with up to four carrier bandwidth parts in the downlink with a single downlink carrier bandwidth part being active at a given time. A UE can be configured with up to four carrier bandwidth parts in the uplink with a single uplink carrier bandwidth part being active at a given time. If a UE is configured with a supplementary uplink, the UE can, in addition, be configured with up to four carrier bandwidth parts in the supplementary uplink with a single supplementary uplink carrier bandwidth part being active at a given time.

For a carrier bandwidth part with a given numerology μᵢ, a contiguous set of physical resource blocks (PRBs) is defined and numbered from 0 to N_{BWP,i}^{size}−1, where i is the index of the carrier bandwidth part. A resource block (RB) is defined as 12 consecutive subcarriers in the frequency domain.

### Numerologies

Multiple OFDM numerologies, are supported in NR as given by Table 1, where the subcarrier spacing, Δf, and the cyclic prefix for a carrier bandwidth part are configured by different higher layer parameters for downlink and uplink, respectively.

TABLE 1
Supported transmission numerologies

| μ | Δf = 2^{μ} · 15 [kHz] | Cyclic prefix |
|---|---|---|
| 0 | 15 | Normal |
| 1 | 30 | Normal |
| 2 | 60 | Normal, Extended |
| 3 | 120 | Normal |
| 4 | 240 | Normal |

### Physical Channels

A downlink physical channel corresponds to a set of resource elements carrying information originating from higher layers. The following downlink physical channels are defined: Physical Downlink Shared Channel (PDSCH); Physical Broadcast Channel (PBCH); and Physical Downlink Control Channel (PDCCH).

PDSCH is the main physical channel used for unicast downlink data transmissions, but also for transmission of RAR (random access response), certain system information blocks, and paging information. PBCH carries the basic system information, required by the UE to access the network. PDCCH is used for transmitting downlink control information (DCI), mainly scheduling decisions, required for reception of PDSCH, and for uplink scheduling grants enabling transmission on PUSCH.

An uplink physical channel corresponds to a set of resource elements carrying information originating from higher layers. The following uplink physical channels are defined: Physical Uplink Shared Channel (PUSCH); Physical Uplink Control Channel (PUCCH); and Physical Random Access Channel (PRACH).

PUSCH is the uplink counterpart to the PDSCH. PUCCH is used by UEs to transmit uplink control information, including Hybrid Automatic Repeat Request (HARD) acknowledgements, channel state information reports, etc. PRACH is used for random access preamble transmission.

### Frequency Resource Allocation for PUSCH

In general, a UE shall determine the RB assignment in the frequency domain for PUSCH or PDSCH, using the resource allocation field in the detected DCI carried in PDCCH. For PUSCH carrying msg3 in a random-access procedure, the frequency domain resource assignment is signaled by using the uplink (UL) grant contained in RAR.

In NR, two frequency resource allocation schemes, type 0 and type 1, are supported for PUSCH and PDSCH. Which type to use for a PUSCH/PDSCH transmission is either defined by a Radio Resource Control (RRC) configured parameter or indicated directly in the corresponding DCI or UL grant in RAR (for which type 1 is used).

The RB indexing for uplink/downlink type 0 and type 1 resource allocation is determined within the UE's active carrier bandwidth part, and the UE shall, upon detection of PDCCH intended for the UE, determine first the uplink/downlink carrier bandwidth part (BWP) and then the resource allocation within the carrier bandwidth part. The UL BWP for PUSCH carrying msg3 is configured by higher layer parameters.

Time resource allocations for PUSCH

When the UE is scheduled to transmit a transport block, the Time domain resource assignment field value m of the DCI provides a row index m+1 to an allocated RRC configured table. The indexed row defines: the slot offset K₂, the start and length indicator SLIV, or directly the start symbol S and the allocation length L and the PUSCH mapping type to be applied in the PUSCH transmission.

The slot where the UE shall transmit the PUSCH is determined by K2 as

$$⌊ n \cdot \frac{{2}^{μ} P U S C H}{{2}^{μ} P D C C H} ⌋ + {K}_{2} ,$$

where n is the slot with the scheduling DCI, K₂ is based on the numerology of PUSCH, and μ_{PUSCH} and μ_{PDCCH} are the subcarrier spacing configurations for PUSCH and PDCCH, respectively.

The starting symbol S relative to the start of the slot, and the number of consecutive symbols L counting from the symbol S allocated for the PUSCH are determined from the start and length indicator SLIV of the indexed row:
if (L−1)≤7 then SLIV=14·(L−1)+S, else SLIV=14·(14−L+1)+(14−1−S), where 0<L≤14−S.

The UE shall consider the S and L combinations defined in Table 2 as valid PUSCH allocations.

TABLE 2
Valid S and L combinations

| PUSCH | | | | | | |
|---|---|---|---|---|---|---|
| mapping | Normal cyclic prefix | | | Extended cyclic prefix | | |
| type | S | L | S + L | S | L | S + L |
| Type A | 0 | {4, . . . ,14} | {4, . . . ,14} | 0 | {4, . . . ,12} | {4, . . . ,12} |
| Type B | {0, . . . ,13} | {1, . . . ,14} | {1, . . . ,14} | {0, . . . ,12} | {1, . . . ,12} | {1, . . . ,12} |

Either a default PUSCH time-domain allocation A according to Table 3, is applied, or the higher layer configured pusch-AllocationList in either pusch-ConfigCommon or pusch-Config is applied. The value j depends on the subcarrier spacing and is defined in Table 4.

TABLE 3
Default PUSCH time domain resource allocation A for normal CP

| | PUSCH | | | |
|---|---|---|---|---|
| Row index | mapping type | K₂ | S | L |
| 1 | Type A | j | 0 | 14 |
| 2 | Type A | j | 0 | 12 |
| 3 | Type A | j | 0 | 10 |
| 4 | Type B | j | 2 | 10 |
| 5 | Type B | j | 4 | 10 |
| 6 | Type B | j | 4 | 8 |
| 7 | Type B | j | 4 | 6 |
| 8 | Type A | j + 1 | 0 | 14 |
| 9 | Type A | j + 1 | 0 | 12 |
| 10 | Type A | j + 1 | 0 | 10 |
| 11 | Type A | j + 2 | 0 | 14 |
| 12 | Type A | j + 2 | 0 | 12 |
| 13 | Type A | j + 2 | 0 | 10 |
| 14 | Type B | j | 8 | 6 |
| 15 | Type A | j + 3 | 0 | 14 |
| 16 | Type A | j + 3 | 0 | 10 |

TABLE 4
Definition of value j

| μ_{PUSCH} | j |
|---|---|
| 0 | 1 |
| 1 | 1 |
| 2 | 2 |
| 3 | 3 |

The pusch-AllocationList can be configured, via higher layer signaling, as follows:

| -- ASN1START | | |
|---|---|---|
| -- TAG-PUSCH-TIMEDOMAINRESOURCEALLOCATIONLIST-START | | |
| PUSCH-TimeDomainResourceAllocationList ::= SEQUENCE (SIZE(1..maxNrofUL- | | |
| Allocations)) OF PUSCH-TimeDomainResourceAllocation | | |
| PUSCH-TimeDomainResourceAllocation ::= SEQUENCE { | | |
| k2 | INTEGER(0..32) | OPTIONAL, -- Need S |

| | |
|---|---|
| mappingType | ENUMERATED {typeA, typeB}, |
| startSymbolAndLength | INTEGER (0..127) |

}
-- TAG-PUSCH-TIMEDOMAINRESOURCEALLOCATIONLIST-STOP
-- ASN1STOP

The fields are defined as follows. The field k2 corresponds to L1 parameter “K2” (see TS 38.214, clause 6.1.2.1). When the field is absent, the UE applies the value 1 when PUSCH SCS is 15/30 kHz, the value 2 when PUSCH SCS is 60 kHz, and the value 3 when PUSCH SCS is 120 KHz. The field mappingType is defined in TS 38.214, clause 6.1.2.1. The field startSymbolAndLength is an index giving valid combinations of start symbol and length (jointly encoded) as start and length indicator (SLIV). The network configures the field so that the allocation does not cross the slot boundary. (see TS 38.214, clause 6.1.2.1).

### Modulation Order, Redundancy Version and Transport Block Size Determination

To determine the modulation order, target code rate, redundancy version and transport block size for the physical uplink shared channel, the UE shall first read the 5-bit modulation and coding scheme field (I_{MCS}) in the DCI to determine the modulation order (0ₘ) and target code rate R. The will read redundancy version field (RV) in the DCI to determine the redundancy version, and check the “CSI request” bit field and second. The UE shall use the number of layers (v), the total number of allocated PRBs (n_{PRB}) to determine the transport block size.

In the 3GPP NR standard, DCI is received over the PDCCH. The PDCCH may carry DCI in messages with different formats. DCI format 0_0 and 0_1 are DCI messages used to convey uplink grants to the UE for transmission of the physical layer data channel in the uplink (PUSCH) and DCI format 1_0 and 1_1 are used to convey downlink grants for transmission of the physical layer data channel on the downlink (PDSCH). Other DCI formats (2_0, 2_1, 2_2 and 2_3) are used for other purposes such as transmission of slot format information, reserved resource, transmit power control information, etc.

### Slot Structure

An NR slot consists of several OFDM symbols, either 7 or 14 symbols (OFDM subcarrier spacing ≤60 kHz) and 14 symbols (OFDM subcarrier spacing >60 kHz). FIG. 2 shows a subframe with 14 OFDM symbols. In FIG. 2, Tₛ and T_{symb} denote the slot and OFDM symbol duration, respectively. In addition, a slot may also be shortened to accommodate DL/UL transient period or both DL and UL transmissions. Potential variations are shown in FIG. 3.

Furthermore, NR also defines Type B scheduling, also known as mini-slots. Mini-slots are shorter than slots (according to current agreements from 1 or 2 symbols up to number of symbols in a slot minus one) and can start at any symbol. Mini-slots are used if the transmission duration of a slot is too long or the occurrence of the next slot start (slot alignment) is too late. Applications of mini-slots include, among others, latency critical transmissions (in this case both mini-slot length and frequent opportunity of mini-slot are important) and unlicensed spectrum where a transmission should start immediately after listen-before-talk succeeded (here the frequent opportunity of mini-slot is especially important). An example of a mini-slot is shown in FIG. 4.

### Slot Structure

For a node to be allowed to transmit in unlicensed spectrum, e.g., the 5 GHz band, it typically needs to perform a clear channel assessment (CCA). This procedure typically includes sensing the medium to be idle for a number of time intervals. Sensing the medium to be idle can be done in different ways, such as by using energy detection, preamble detection or using virtual carrier sensing. The latter implies that the node reads control information from other transmitting nodes informing when a transmission ends. After sensing the medium idle a node is typically allowed to transmit for a certain amount of time, sometimes referred to as transmission opportunity (TXOP). The length of the TXOP depends on regulation and type of CCA that has been performed, but typically ranges from 1 ms to 10 ms.

The mini-slot concept in NR allows a node to access the channel at a much finer granularity as compared to, for example, Long Term Evolution (LTE) Licensed Assisted Access (LAA), where the channel could only be accessed at 500 us intervals. Using, for example, 60 kHz subcarrier-spacing and a two-symbol mini-slot in NR, the channel can be accessed at 36 us intervals.

### SUMMARY

NR allows the scheduling of multiple slots, each with a separate UL grant. This can easily exhaust PDCCH resources when the scheduled UL bursts are long and/or the number of UEs to be scheduled is high. The latter adds restrictions to the scheduling procedures, and unnecessarily wastes PDCCH resources.

Some solutions involve scheduling multiple slots; however, the focus is on how to signal the time resource allocation. The solutions do not consider behavior changes when activating multi-slot scheduling in combination with other features, or how to signal parameters other than the time resource allocation.

Embodiments described herein are directed to a technique that can schedule both single or multiple PUSCHs using a single scheduling message (e.g., a single DCI). Advantages include reducing overhead on PDCCH by sending scheduling information for multiple slots using one grant, which enables efficient UL scheduling and transmission when multiple starting/ending positions is supported. Another advantage is added flexibility in scheduling the multiple slots.

According to some embodiments, a method, in a network node of a wireless communication system, for multi-interval scheduling downlink or uplink transmissions to or from a wireless communication device, includes sending, to the wireless device, configuration information indicating one or both of a maximum number of scheduling intervals that can be scheduled with a single scheduling message and a time-domain resource allocation data structure to be used when multi-interval scheduling is in use.

A “scheduling interval” may refer to a slot, a mini-slot, a subframe, etc., with the point being that each of these intervals can be separately scheduled (at least in the frequency domain) within the scheduling message. The scheduling message may refer to a DCI or a similar dynamic scheduling message.

According to some embodiments, a method, in a network node of a wireless communication system, for multi-interval scheduling downlink or uplink transmissions to or from a wireless communication device, includes scheduling one or more downlink or uplink transmissions to or from the wireless communication device, using a single scheduling message scheduling a transmission in each of multiple scheduling intervals. The number of scheduled intervals is indicated in the scheduling message by a dedicated field in or by a time resource assignment indication that implicitly or explicitly indicates the number of scheduled intervals.

According to some embodiments, a method, in a wireless communication device operating in a wireless communication system, for multi-interval scheduling of downlink or uplink transmissions to or from the wireless communication device, includes receiving, from a network node in the wireless communication system, configuration information indicating one or both of a maximum number of scheduling intervals that can be scheduled with a single scheduling message and a time-domain resource allocation data structure to be used when multi-interval scheduling is in use.

According to some embodiments, a method, in a wireless communication device operating in a wireless communication system, for multi-interval scheduling of downlink or uplink transmissions to or from the wireless communication device, includes receiving scheduling information for one or more downlink or uplink transmissions to or from the wireless communication device, in a single scheduling message scheduling a transmission in each of multiple scheduling intervals. The number of scheduled intervals is indicated in the scheduling message by a dedicated field in or by a time resource assignment indication that implicitly or explicitly indicates the number of scheduled intervals.

Of course, the present invention is not limited to the above features and advantages. Those of ordinary skill in the art will recognize additional features and advantages upon reading the following detailed description, and upon viewing the accompanying drawings.

### BRIEF DESCRIPTION OF THE FIGURES

FIG. 1 illustrates an example of radio resources in NR.

FIG. 2 illustrates a subframe.

FIG. 3 illustrates slot variations.

FIG. 4 illustrates a mini-slot of two OFDM symbols.

FIG. 5 illustrates use of a TDRA table, according to some embodiments.

FIG. 6 illustrates is a block diagram of a network node, according to some embodiments.

FIG. 7 illustrates a flowchart for a method in the network node, according to some embodiments.

FIG. 8 illustrates a flowchart for another method in the network node, according to some embodiments.

FIG. 9 illustrates is a block diagram of a wireless device, according to some embodiments.

FIG. 10 illustrates a flowchart for a method in the wireless device, according to some embodiments.

FIG. 11 illustrates a flowchart for another method in the wireless device, according to some embodiments.

FIG. 12 schematically illustrates a telecommunication network connected via an intermediate network to a host computer, according to some embodiments.

FIG. 13 is a generalized block diagram of a host computer communicating via a base station with a user equipment over a partially wireless connection, according to some embodiments.

FIG. 14, FIG. 15, FIG. 16, and FIG. 17 are flowcharts illustrating example methods implemented in a communication system including a host computer, a base station and a user equipment.

FIG. 18 is a block diagram illustrating a functional implementation of a network node, according to some embodiments.

FIG. 19 is a block diagram illustrating a functional implementation of a wireless device, according to some embodiments.

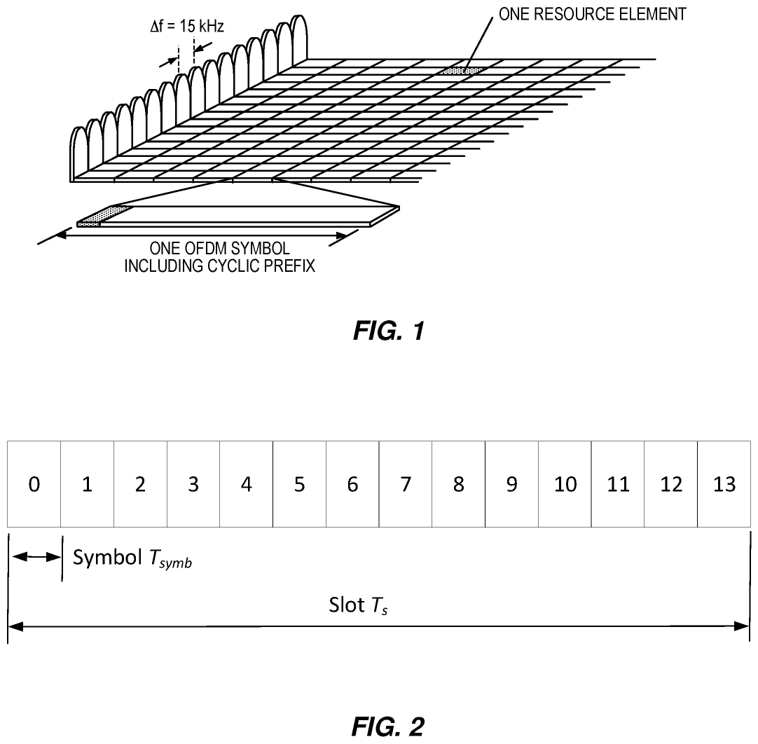

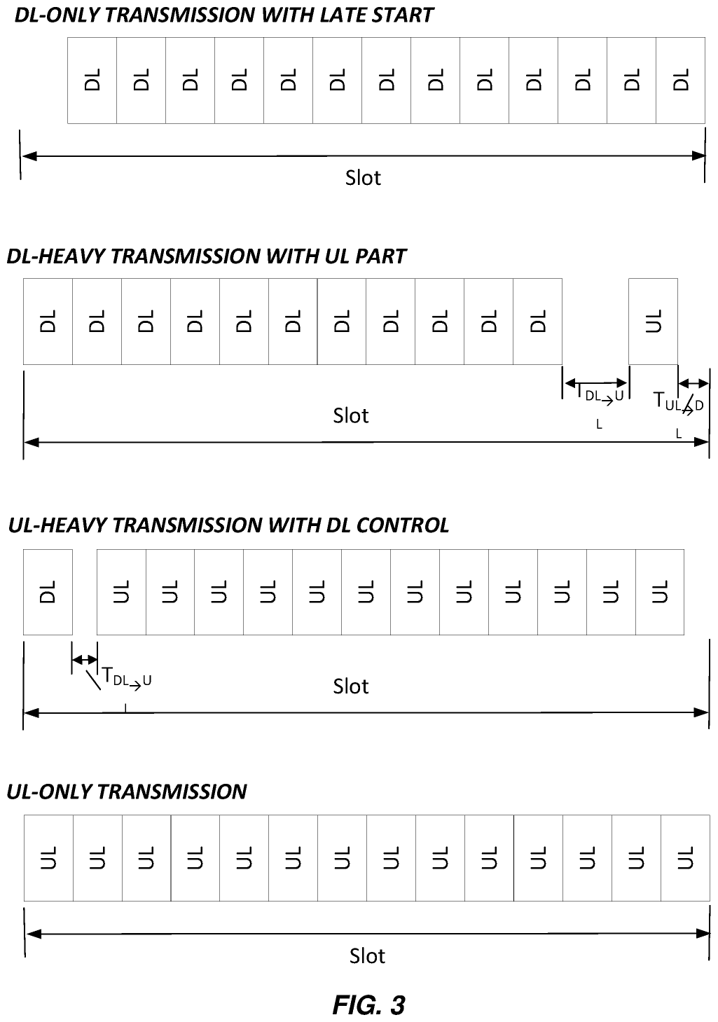

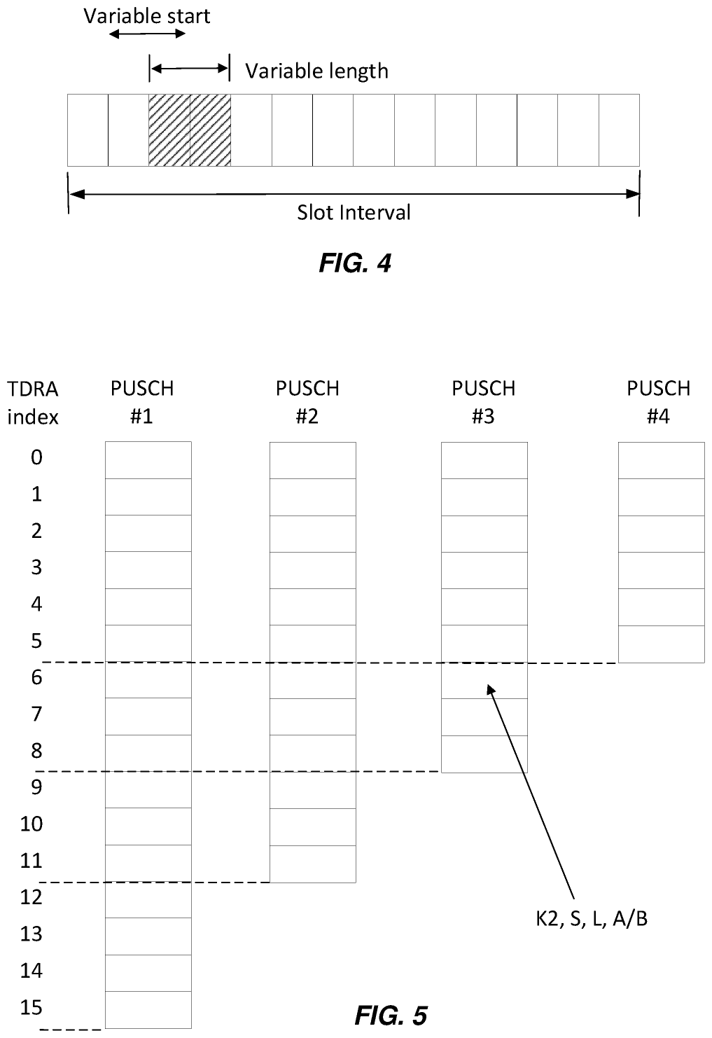

### DETAILED DESCRIPTION

Exemplary embodiments of the present disclosure will now be described more fully hereinafter with reference to the accompanying drawings, in which examples of embodiments of inventive concepts are shown. Inventive concepts may, however, be embodied in many different forms and should not be construed as limited to the embodiments set forth herein.

Rather, these embodiments are provided so that this disclosure will be thorough and complete, and will fully convey the scope of present inventive concepts to those skilled in the art. It should also be noted that these embodiments are not mutually exclusive. Components from one embodiment can be tacitly assumed to be present/used in another embodiment. Any two or more embodiments described in this document may be combined with each other. The embodiments are described with respect to LTE or NR, but can be adapted in other radio access technologies where the techniques or selections may be relevant.

Embodiments described herein are directed to a technique that can schedule either single or multiple PUSCHs using a single scheduling message (e.g., single DCI). The term PUSCH is used to refer to an uplink transmission in a particular interval. Thus, PUSCH transmissions in consecutive intervals (e.g., consecutive slots) are referred to herein as both “multi-slot” transmissions and “multi-PUSCH” transmissions. These are intended to refer to the same thing. Likewise, multi-slot scheduling and multi-PUSCH scheduling are meant to refer to the same thing, with “multi-interval scheduling” being somewhat more general (in that it may include other types of physical channels). While PUSCH scheduling is discussed in the embodiments, the techniques described here can be applicable to multi-slot PDSCH scheduling as well.

In one embodiment, the scheduling of multiple PUSCHs using single DCI functionality is enabled or disabled via RRC. The RRC configuration includes one or more of the following parameters: the maximum number PUSCH that can be scheduled using single DCI; and

PUSCH-TimeDomainResourceAllocation data structure that is used when the functionality is enabled. If the functionality is enabled via RRC, the same DCI format indicates if one or more PUSCH are scheduled. As a non-limiting example, DCI 0_1 can schedule one or more PUSCH(s).

According to some embodiments, the number of scheduled PUSCH (Nslots) is signaled via DCI either by: a dedicated field where the bit width of the field is configurable based on the maxNumberOfSchedSlots (e.g., log 2(maxNumberOfSchedSlots)); or being embedded implicitly or explicitly in the time resource assignment. As an example, the PUSCH-TimeDomainResourceAllocation includes a column that indicates the number of scheduled PUSCH.

In some embodiments, if Nslots is signaled using a dedicated field, there may be at least two conditions. If Nslots indicates 1, time resource assignment maps to existing PUSCH-allocation table (Rel-15). If Nslots indicates >1, time resource assignment maps to new PUSCH-MultiSlotTimeDomainResourceAllocation. PUSCH-MultiSlotTimeDomainResource Allocation includes one or more of the following: row index; PUSCH mapping type (mapping type for the first number of scheduled slot); PUSCH mapping type2 (mapping type for the remaining scheduled slots); K2 slot offset for the first scheduled PUSCH; S (start symbol); L (length of PUSCH); and startAndEndSlot (flag to indicate one of the two choices). Choice 1 is the possibility of scheduling one or multiple PUSCH with gaps in between using a single DCI. Start symbol S and length L values are applied to each scheduled slot using the corresponding DCI. Choice 2 is one or multiple scheduled PUSCH with no gaps in between using a single DCI. Start symbol S may be of the first scheduled slot and length of PUSCH L of the last scheduled slot. It is implicitly indicated that, for all other scheduled slots in the multi-slot scheduling, the start symbol is #0 and the length is the same as the slot.

TABLE 4
Definition of value j

| | PUSCH | PUSCH | | | | |
|---|---|---|---|---|---|---|
| Row | mapping | mapping | | | | |
| index | type1 | type2 | K₂ | S | L | startAndEndSlot |
| | mapping | mapping | | | | Value [ true or false ] |
| | type for | type for | | | | if false: start symbol and length values |
| | the first | the | | | | are applied to every scheduled slot. |
| | scheduled | remaining | | | | if true: start symbol of the first |
| | slot | scheduled | | | | scheduled slot and the length of the last |
| | | slots | | | | scheduled slot. It's implicitly indicated |
| | | | | | | that, for all other scheduled slots in the |
| | | | | | | multi-slot scheduling, the start symbol is |
| | | | | | | #0 and the length is the same as the slot. |

Instead of indicating PUSCH mapping type 1 and 2 separately, one of the following alternatives is used: single PUSCH mapping type is indicated that is applicable to all scheduled PUSCHs; and single PUSCH mapping type is indicated. first number of scheduled slot is transmitted using mapping type B, and the indicated mapping type is applicable starting from the second slot.

In some embodiments, if Codeblock group feedback is configured and activated, there are at least two conditions. If Nslots indicates 1, redundancy version (RV) and New Data Indicator (NDI) are indicated for one slot (i.e., RV is two bits, NDI is one bit), and DCI indicates code block group (CBG) transmission information (CBGTI) information corresponding to the scheduled PUSCH. If Nslots indicates >1, CBGTI is not supported in case the DCI is scheduling multiple PUSCH, the field not included in DCI, and each of the RV and NDI bit width is equal to the maximum number of scheduled slots in RRC configuration. Zero padding might be needed to align the DCI length for the two cases.

In some embodiments, the Time Domain Resource Allocation (TDRA) table for multi-slot scheduling can be constructed as a simple extension of single slot scheduling. The TDRA table provides information for each individual PUSCH. There is a separate K2, S, L, mapping type corresponding to each PUSCH. As one variation of these embodiments, the number of columns depend on the number of maximum number of scheduled PUSCHs. As an example, if the maximum number of scheduled PUSCH is 4, the table provides four K2, S, L, mapping type values each corresponding to one schedulable PUSCH.

The number of scheduled PUSCH is implicitly indicated by the TDRA table. If a PUSCH is not to be scheduled, the corresponding (K2, S, L, mapping type) is set to non-valid/empty values. FIG. 5 shows an example where the TDRA table provides the time resource allocation for up to 4 PUSCH. Each row indicates (K2, S, L, mapping type) corresponding to each PUSCH. In this setup, the number of scheduled slots is obtained from the RRC configured table. For example, in case of row 0 to 5, four PUSCH are scheduled. In row 6 to 8, the number of scheduled PUSCH is three. To indicate that, the entry corresponding to the fourth PUSCH is left empty or set to a non-valid value.

In another variation of these embodiments, the number of columns in the table is not increased. Instead, one or more of the following fields is replaced with a list of values, with one list entry for each of the number of scheduled slots: PUSCH mapping type; S (start symbol); L (length of PUSCH); and K2 (offset to the scheduled PUSCH). In yet another variation, the RCC configured PUSCH-TimeDomainResourceAllocation, which is a sequence of (K2, mapping type and startSymbolAndLength), is extended—so that the gNB provides a list of PUSCH-TimeDomainResourceAllocation. The list can be of fixed or variable size. The maximum size of the list depends on the maximum number of schedulable PUSCHs.

In some embodiments, if the number of entries in the data structure PUSCH-MultiSlotTimeDomainResourceAllocation is 2^{N}, where N is the number of available DCI bits for indicating the row of PUSCH-MultiSlotTimeDomainResourceAllocation, then a Medium Access Control Command Element (MAC CE) message is used to “activate” or “select” a subset of N or fewer entries of the PUSCH-MultiSlotTimeDomainResourceAllocation data structure. The available DCI codepoints are then mapped to the entries in the selected subset.

In some embodiments, the allocations are allocated back to back (i.e., no gaps in between) and each allocation can be shorter or longer than (or equally long as) a slot. The start symbol S is provided for the first allocation and then only the length of each allocation is needed. This could be a single parameter, applicable to all allocations (i.e., they all have the same length, i.e., the same number of symbols) or one length indication per allocation (i.e., a list of lengths). In these embodiments, the Nslots parameter indicates the number of allocations rather than the number of slots. The Nslots parameter may thus be replaced by an Nallocations parameter in this embodiment.

In some embodiments, the allocations (which each may contain fewer, more symbols than a slot or an equal number of symbols as a slot (i.e., 14)) are allocated with gaps (which may be zero or more symbols long) in between allocations. The length of each allocation and each intermediate gap could be the same for all allocations, requiring only a single length indication and a single gap length indication. Alternatively, the allocation length can be the same for all allocations (i.e., a single allocation length indication), but the gap length is indicated per gap (e.g., as a list). Another alternative is that the gap length is the same for all gaps (i.e., a single gap length indication), but the allocation length is indicated per allocation (e.g., as a list). Yet another alternative is that both the allocation length and the gap length are provided as multiple parameters or values (e.g., as lists), one for each allocation and one for each gap. In these embodiments, the Nslots parameter indicates the number of allocations rather than the number of slots. The Nslots parameter may thus be replaced by an Nallocations parameter in these embodiments.

In another variation of the previous embodiments, there are multiple allocations of possibly varying lengths and with intermediate gaps of possibly varying lengths. The allocated symbols are indicated as a bitmap (e.g., with 0 meaning gap and 1 meaning allocation). This embodiment is restricted to non-zero gaps in all places. The reason for restricting these embodiments to allocations with non-zero gaps in between is that if there is no gap between two allocations, then some further indication would be needed to indicate the border between the two allocations. As a further enhancement, such an indication, and/or rule, could be provided to enable multi-allocations with non-zero intermediate gaps.

One way to do this is to provide a single maxAllocationLength indication, which should be interpreted such that if a series of consecutive bits set to one includes more bits than maxAllocationLength, but fewer than 2×maxAllocationLength, then the series of bits is divided into two allocations of equal size. If the number of bits in the series is odd, then the first allocation has one bit more than the second (the rule could equally well be that the second allocation has one bit more than the first one). This can be generalized to more than two back-to-back allocations and the following rule/algorithm could be applied, for example. N is the number of symbols in the number of consecutively allocated symbols (i.e., the number of consecutive bits set to 1 in the bitmap). D is the CEILING(N/maxAllocationLength) (i.e., N/maxAllocationLength rounded to the nearest higher integer). The series of allocated symbols will be divided into D separate allocations: Allocation1, AllocationD. The length of each allocation in number of symbols is determined as follows: B=FLOOR(N/D) (i.e., N/D rounded to the nearest lower integer, also known as integer division); and R=MODULO(N/D). Each allocation (1 . . . D) is assigned B consecutive symbols. Then, if R>0, the R remaining symbols (which are fewer than D) are distributed one symbol to each consecutive allocation (starting with Allocation1) until the R bits are finished.

In some embodiments, which may be applicable as an extension of any or all of the other embodiments, the DCI indicates whether the UE is allowed to use only one of the multiple allocations (i.e., redundant allocations are provided to proactively compensate for potential Listen Before Talk (LBT) failures) or all or a subset of them. If the UE is allowed to use only one or a subset of the allocations, it is not predetermined which this/these allocations is/are, because it depends on the outcome of the LBT procedure. As soon as the UE has managed to utilize as many allocations as it is allowed to utilize (or fewer if it has drained its UL buffer of pending UL data), it can ignore any remaining allocations.

In the case where the UE is allowed to use multiple allocations, the HARQ process ID and possibly RV could be provided per allocation. An alternative to providing the HARQ process ID per allocation could be to indicate a single HARQ process ID for all allocations or to indicate the HARQ process ID for the first allocation and then indicate that in order round robin should be used to step through the other configured HARQ processes for the remaining consecutive allocations. For the RV indication, an alternative to providing it for each allocation could be, in case of a single HARQ process ID, to only provide one RV indication to be used for the first allocation and then the RVs used for the remaining allocations follow the order indicated in table 6.1.2.1-2 of TS 38.214 (shown below as Table 5).

TABLE 5

| rv_{id} indicated | | | | |
|---|---|---|---|---|
| by the DCI | | | | |
| scheduling | rv_{id} to be applied to n^{th} transmission occasion | | | |
| the PUSCH | n mod 4 = 0 | n mod 4 = 1 | n mod 4 = 2 | n mod 4 = 3 |
| 0 | 0 | 2 | 3 | 1 |
| 2 | 2 | 3 | 1 | 0 |
| 3 | 3 | 1 | 0 | 2 |
| 1 | 1 | 0 | 2 | 3 |

If multiple HARQ processes are used, then a first RV would be provided per allocation and then the above mentioned (and recited) table would be followed for the remaining allocations per HARQ process. Another piece of information that could be provided per allocation, or once for all allocations, is the cyclic prefix (CP) to use.

In all the above where additional information is provided per allocation, this could apply to all allocations, i.e., equally many information instances would be provided as the number of allocations (disregarding the information that is provided only once for all allocations) or per allowed allocation, i.e., equally many information instances as the number of allocations the UE is allowed to use (disregarding the information that is provided only once for all allocations). In the latter case, since the parameters (such as HARQ process ID or RV) are not tied to the actual time/frequency resource allocation, the gNB has to keep track of the order in which it receives transmissions from the UE to be able to apply the correct configuration parameters (e.g., HARQ process ID or RV) to the received PUSCH transmission.

An additional option that may be used when the UE is allowed to use multiple allocations is that the LBT category, if any, to use before each allocation (excluding allocations which are preceded by a back-to-back allocation without gap in between) could be indicated. The same LBT category could be indicated for all allocations (requiring only a single indication) or the LBT category could be indicated per allocation (e.g., as a list). A possible streamlining of such indications could be that, for instance, two different LBT categories are configured and a bitmap (with one bit per allocation) indicates which of these two LBT categories to apply to each allocation).

Yet another additional piece of information that could be provided—the same single indication for all allocations or one indication per allocation—is the LBT priority class (in case of LBT category 4). Yet another piece of information that could be provided—the same single indication for all allocations or one indication per allocation—is an energy detection threshold to be used in the LBT procedure. A device, such as a UE, uses an energy detection threshold when monitoring the radio channel during an LBT procedure and if energy is detected at a level above the threshold, the device determines that the channel is occupied and refrains from transmitting. Conversely, if detected energy is below the threshold, the device determines that the channel is free and goes ahead to transmit using the channel.

A possible use case for providing an energy detection threshold per allocation could be to increase the threshold (ramp it up, making it more generous) for later allocations than earlier, e.g., by increasing it with a small step for each allocation or by having the same energy detection threshold for all but the last allocation for which it is increased. The purpose of increasing it for later allocations would be to increase the chances that the LBT procedure is successful (since the UE assumedly has failed LBT for the preceding allocations) and the UE thus successfully access the channel.

In various other embodiments, several, possibly rather elaborated, multi-allocation scheduling configurations are configured via RRC signaling (the system information or dedicated signaling) or MAC signaling or even specified in the standard. The configurations could be referenced with an index in the DCI. This can apply to the entire multi-allocation (all parameters) or parts of it (some of the parameters). This type of indication is particularly useful when the multi-allocation includes so much information that the number of available bits in the DCI would be exceeded if the multi-allocation were explicitly provided in the DCI. Multi-allocations when the UE is allowed to use multiple allocations and configuration information is provided per allocation, as described above in the previous embodiment, could be one example of a type of multi-allocation that could benefit from this type of index-based indication in the DCI. An example of this type of index indication would be where one index points out the entire multi-allocation configuration (including parameters for all PUSCH transmission resource allocations).

In some embodiments, which may complement any of the other embodiments, different frequency resources may be allocated for different allocations in a DCI containing multiple resource allocations. Different allocations could, for instance, indicate frequency resources on another sub-band (i.e., another part of the spectrum) where the channel occupancy may be different, e.g., if per-sub-band LBT is used. Another conceivable use case is to avoid some other activity occupying the frequency resources. For instance, a UE could be allocated four allocations, where the first three use the frequencies of the DRS (but not overlapping the DRS in time), while the fourth allocation overlaps the DRS in time and is therefore allocated other frequency resources not overlapping with the DRS. This could be frequencies on one side of the DRS or spanning across the DRS on both sides and the UE is assumed (or instructed) to rate match around the DRS.

Frequency resources could be indicated per allocation in the DCI (e.g., as a list). Or (to save bits), two frequency allocations could be provided and for each allocation there is an indication which of the two frequency allocations that apply. One attractive way could be to extend the frequency domain resource allocation table from a single to multiple columns, similar to the way the time domain resource allocation table is extended to multiple columns. A single (table row) index would thus point out frequency resource allocations for multiple PUSCH allocations (where each column represents one allocation). If combined with the multi-column TDRA table in FIG. 5, the columns should be ordered and associated with PUSCH resource allocations in the same manner in both the multi-column time domain resource allocation table and the multi-column frequency domain resource allocation table, such that the n^{th} column is associated with the n^{th} PUSCH resource allocation in the DCI, the same principle in both multi-column tables. In some embodiments, the energy detection threshold could increase with later allocations.

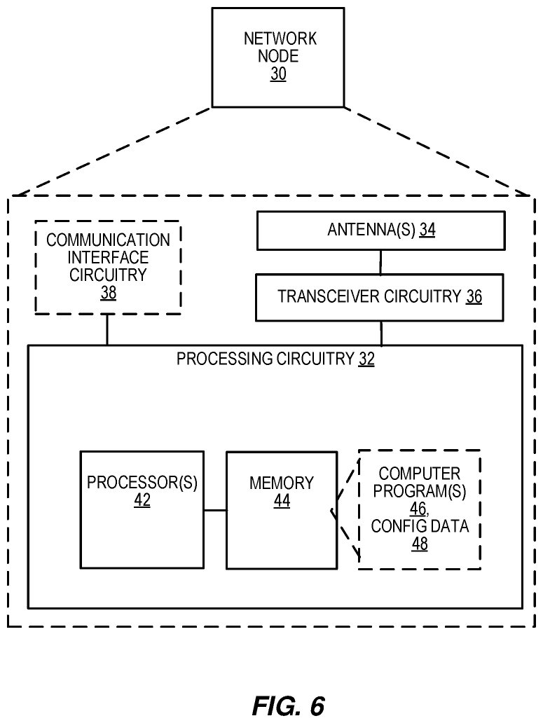

The multiple embodiments described above may be carried out by a network node and a corresponding wireless device. FIG. 6 shows such a network node 30, which may be referred to as a “base station”. The network node 30 may be a gNB. While a network node 30 is shown in FIG. 6, the network node operations can be performed by other kinds of network access nodes or relay nodes. In the non-limiting embodiments described below, the network node 30 will be described as being configured to operate as a cellular network access node in an NR network, but the embodiments are not limited to NR or just cellular technologies.

Those skilled in the art will readily appreciate how each type of node may be adapted to carry out one or more of the methods and signaling processes described herein, e.g., through the modification of and/or addition of appropriate program instructions for execution by processing circuitry 32.

Network node 30 facilitates communication between wireless terminals, other network access nodes and/or the core network. Network node 30 may include communication interface circuitry 38 that includes circuitry for communicating with other nodes in the core network, radio nodes, and/or other types of nodes in the network for the purposes of providing data and/or cellular communication services. Network node 30 communicates with wireless devices using antennas 34 and transceiver circuitry 36. Transceiver circuitry 36 may include transmitter circuits, receiver circuits, and associated control circuits that are collectively configured to transmit and receive signals according to a radio access technology, for the purposes of providing cellular communication services.

Network node 30 also includes one or more processing circuits 32 that are operatively associated with transceiver circuitry 36 and, in some cases, communication interface circuitry 38. Processing circuitry 32 comprises one or more digital processors 42, e.g., one or more microprocessors, microcontrollers, Digital Signal Processors (DSPs), Field Programmable Gate Arrays (FPGAs), Complex Programmable Logic Devices (CPLDs), Application Specific Integrated Circuits (ASICs), or any mix thereof. More generally, processing circuitry 32 may comprise fixed circuitry, or programmable circuitry that is specially configured via the execution of program instructions implementing the functionality taught herein, or may comprise some mix of fixed and programmed circuitry. Processor 42 may be multi-core, i.e., having two or more processor cores utilized for enhanced performance, reduced power consumption, and more efficient simultaneous processing of multiple tasks.

Processing circuitry 32 also includes a memory 44. Memory 44, in some embodiments, stores one or more computer programs 46 and, optionally, configuration data 48. Memory 44 provides non-transitory storage for the computer program 46 and it may comprise one or more types of computer-readable media, such as disk storage, solid-state memory storage, or any mix thereof. Here, “non-transitory” means permanent, semi-permanent, or at least temporarily persistent storage and encompasses both long-term storage in non-volatile memory and storage in working memory, e.g., for program execution. By way of non-limiting example, memory 44 comprises any one or more of SRAM, DRAM, EEPROM, and FLASH memory, which may be in processing circuitry 32 and/or separate from processing circuitry 32. Memory 44 may also store any configuration data 48 used by network access node 30. Processing circuitry 32 may be configured, e.g., through the use of appropriate program code stored in memory 44, to carry out one or more of the methods and/or signaling processes detailed hereinafter.

According to some embodiments, processing circuitry 32 of network node 30 is configured for multi-interval scheduling downlink or uplink transmissions to or from a wireless communication device. Processing circuitry 32 is configured to send, to the wireless device, configuration information indicating one or both of a maximum number of scheduling intervals that can be scheduled with a single scheduling message and a time-domain resource allocation data structure to be used when multi-interval scheduling is in use. The scheduling intervals may be slots or mini-slots.

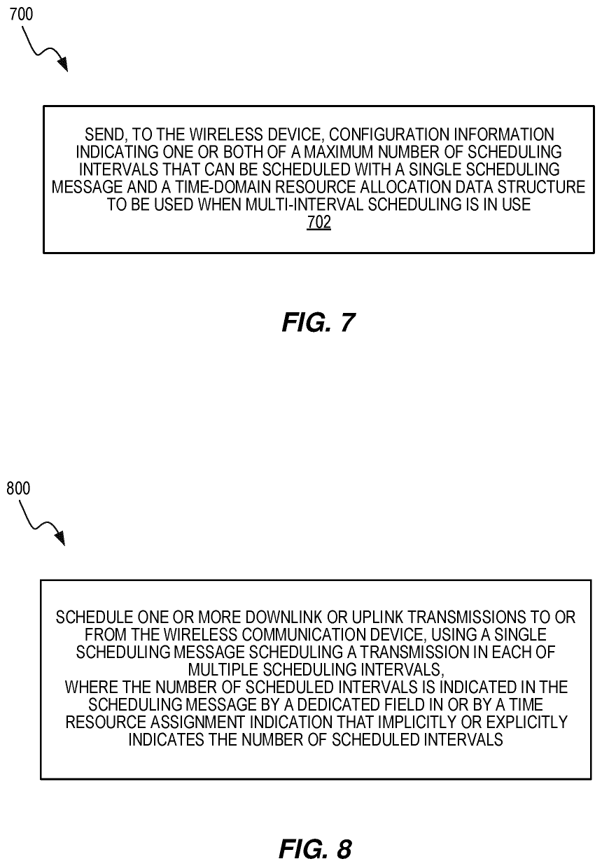

Processing circuitry 32 may be configured to perform a method 700, such as shown by the flowchart in FIG. 7. Method 700 includes sending, to the wireless device, configuration information indicating one or both of a maximum number of scheduling intervals that can be scheduled with a single scheduling message and a time-domain resource allocation data structure to be used when multi-interval scheduling is in use (block 702). Method 700 may also include scheduling one or more downlink or uplink transmissions to or from the wireless communication device, in accordance with the configuration information. The scheduling may be performed using a single scheduling message scheduling a transmission in each of multiple scheduling intervals.

According to other embodiments, processing circuitry 32 is configured to schedule one or more downlink or uplink transmissions to or from the wireless communication device, using a single scheduling message scheduling a transmission in each of multiple scheduling intervals. The number of scheduled intervals is indicated in the scheduling message by a dedicated field in or by a time resource assignment indication that implicitly or explicitly indicates the number of scheduled intervals.

Processing circuitry 32 may thus be configured to perform another method 800, shown in FIG. 8. Method 800 includes scheduling one or more downlink or uplink transmissions to or from the wireless communication device, using a single scheduling message scheduling a transmission in each of multiple scheduling intervals, where the number of scheduled intervals is indicated in the scheduling message by a dedicated field in or by a time resource assignment indication that implicitly or explicitly indicates the number of scheduled intervals (block 802).

Method 800 may also include sending one or more downlink transmissions to the wireless device or receiving one or more uplink transmissions from the wireless communication device, in accordance with the scheduling message. The number of scheduled intervals may be indicated by a dedicated field in the scheduling message, and a time resource assignment indication in the scheduling message may map to a first predetermined table of time resource allocations, where the first predetermined table of time resource allocations differs from a second predetermined table of time resource allocations that is applicable when the number of scheduled intervals is 1. The time resource assignment indication here can refer to a time-domain resource allocation, or more specifically to a time-domain resource allocation index.

Each of one or more entries in the first predetermined table may include any one or more of: a mapping type applicable to a first number of scheduled intervals; a mapping type applicable to scheduled slots other than a first number of scheduled intervals; an interval offset for a first scheduled interval; a start symbol applicable to one or more scheduled intervals; a transmission length applicable to one or more scheduled intervals; and a flag indicating whether start symbol and length values apply to every scheduled slot or to a subset of the slots.

In some embodiments, codeblock group feedback may be configured and activated, and no codeblock group transmission indication field may be included in the scheduling message and each of the RV and NDI bit widths are equal to the maximum number of scheduled slots indicated in configuration information signaled to the wireless communication device.

In some embodiments, the first predetermined table provides, for the time resource assignment indication in the scheduling message, separate scheduling information for each scheduled interval. The number of scheduled intervals may be indicated by the first predetermined table, for the time resource assignment indication in the scheduling message.

Method 800 may include sending a message to the wireless device identifying a subset of the first predetermined table to which the time resource assignment indication in the scheduling message applies. This message can be the MAC CE, which was discussed in an earlier embodiment. Tie this claim to “embodiment 2e” in the description. In some embodiments, the scheduling message schedules uplink transmissions and includes an indication of whether the wireless communication device is permitted to use fewer than all of the multiple intervals scheduled by the scheduling message. In other embodiments, the scheduling message schedules uplink transmissions and includes an indication that the wireless communication device is permitted to use only one of the multiple intervals scheduled by the scheduling message. The scheduling message may include an indication of a listen-before-talk (LBT) priority class, where the indication is applicable to one or to all of the scheduled intervals. The scheduling message may include an indication of an energy detection threshold for listen-before-talk operation, wherein the indication is applicable to one or to all of the scheduled intervals.

Method 800 may include sending, to the wireless communication device, configuration information specifying a plurality of multi-interval scheduling configurations, each multi-interval scheduling configuration may include one or more allocation parameters, and the scheduling message may indicate one of the plurality of multi-interval scheduling configurations. The scheduling message may indicate different frequency resources for different scheduling intervals.

In some embodiments, a resource assignment indication in the scheduling message maps to a first predetermined table of resource allocations, and a resource allocation in the first predetermined table of resource allocations identified by the resource assignment indication indicates different frequency resources for different scheduling intervals.

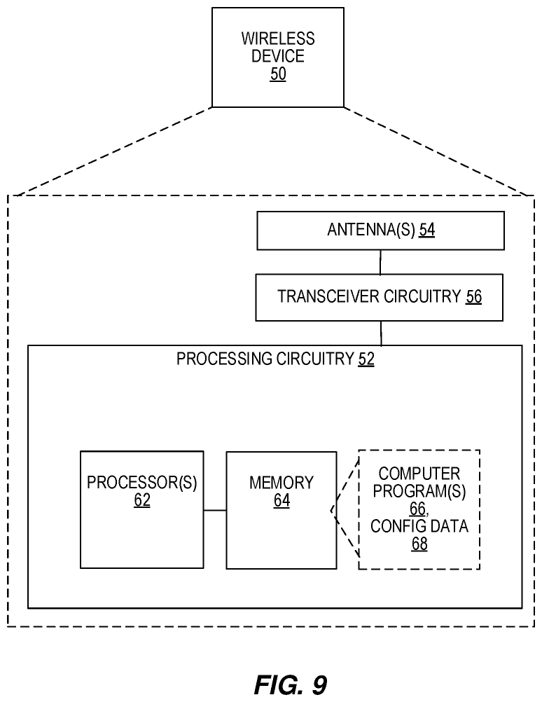

FIG. 9 illustrates an example wireless device 50 (e.g., UE) that is configured to perform the techniques described herein for the wireless communication device. Wireless device 50 may also be considered to represent any wireless devices that may operate in a network and that are capable of communicating with a network node or another wireless device over radio signals. Wireless device 50 may also be referred to, in various contexts, as a radio communication device, a target device, a device-to-device (D2D) UE, a machine-type UE or UE capable of machine to machine (M2M) communication, a sensor-equipped UE, a PDA (personal digital assistant), a wireless tablet, a mobile terminal, a smart phone, laptop-embedded equipment (LEE), laptop-mounted equipment (LME), a wireless USB dongle, a Customer Premises Equipment (CPE), etc.

Wireless device 50 communicates with one or more radio nodes or base stations, such as one or more network nodes 30, via antennas 54 and a transceiver circuitry 56. Transceiver circuitry 56 may include transmitter circuits, receiver circuits, and associated control circuits that are collectively configured to transmit and receive signals according to a radio access technology, for the purposes of providing cellular communication services.

Wireless device 50 also includes processing circuitry 52 that is operatively associated with and controls the radio transceiver circuit 56. Processing circuitry 52 comprises one or more digital processing circuits 62, e.g., one or more microprocessors, microcontrollers, Digital Signal Processors (DSPs), Field Programmable Gate Arrays (FPGAs), Complex Programmable Logic Devices (CPLDs), Application Specific Integrated Circuits (ASICs), or any mix thereof. More generally, processing circuitry 52 may comprise fixed circuitry, or programmable circuitry that is specially adapted via the execution of program instructions implementing the functionality taught herein, or may comprise some mix of fixed and programmed circuitry. Processing circuitry 52 may be multi-core.

Processing circuitry 52 also includes a memory 64. Memory 64, in some embodiments, stores one or more computer programs 66 and, optionally, configuration data 68. Memory 64 provides non-transitory storage for computer program 66 and it may comprise one or more types of computer-readable media, such as disk storage, solid-state memory storage, or any mix thereof. By way of non-limiting example, memory 64 comprises any one or more of SRAM, DRAM, EEPROM, and FLASH memory, which may be in processing circuitry 52 and/or separate from processing circuitry 52. In general, memory 64 comprises one or more types of computer-readable storage media providing non-transitory storage of computer program 66 and any configuration data 68 used by wireless device 50.

Accordingly, in some embodiments, processing circuitry 52 of the wireless device 50 is configured for multi-interval scheduling of downlink or uplink transmissions to or from the wireless communication device. Processing circuitry 52 is configured to receive, from a network node in the wireless communication system, configuration information indicating one or both of a maximum number of scheduling intervals that can be scheduled with a single scheduling message and a time-domain resource allocation data structure to be used when multi-interval scheduling is in use. The scheduling intervals may be slots or mini-slots.

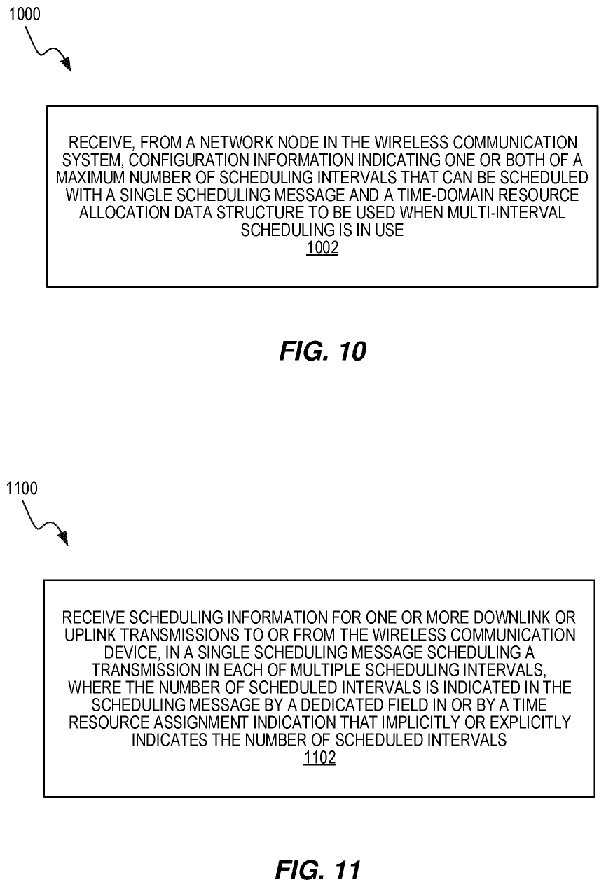

Processing circuitry 52 may also be configured to perform a method 1000 for multi-interval scheduling of downlink or uplink transmissions to or from wireless device 50, shown in FIG. 10. Method 1000 includes receiving, from a network node in the wireless communication system, configuration information indicating one or both of a maximum number of scheduling intervals that can be scheduled with a single scheduling message and a time-domain resource allocation data structure to be used when multi-interval scheduling is in use (block 1002). Method 1000 may include receiving scheduling information for one or more downlink or uplink transmissions to or from the wireless communication device, in accordance with the configuration information. The scheduling information may be received in a single scheduling message scheduling a transmission in each of multiple scheduling intervals.

According to other embodiments, processing circuitry 52 is configured to receive scheduling information for one or more downlink or uplink transmissions to or from the wireless communication device, in a single scheduling message scheduling a transmission in each of multiple scheduling intervals. The number of scheduled intervals is indicated in the scheduling message by a dedicated field in or by a time resource assignment indication that implicitly or explicitly indicates the number of scheduled intervals.

Processing circuitry 52 may be configured to perform a method 1100 for multi-interval scheduling of downlink or uplink transmissions to or from the wireless device 50. Method 1100 includes receiving scheduling information for one or more downlink or uplink transmissions to or from the wireless communication device, in a single scheduling message scheduling a transmission in each of multiple scheduling intervals, where the number of scheduled intervals is indicated in the scheduling message by a dedicated field in or by a time resource assignment indication that implicitly or explicitly indicates the number of scheduled intervals (block 1102).

Method 1100 may include sending one or more uplink transmissions or receiving one or more downlink transmissions, in accordance with the scheduling message. The number of scheduled intervals may be indicated by a dedicated field in the scheduling message, and a time resource assignment indication in the scheduling message may map to a first predetermined table of time resource allocations, where the first predetermined table of time resource allocations differs from a second predetermined table of time resource allocations that is applicable when the number of scheduled intervals is 1. In some embodiments, each of one or more entries in the first predetermined table comprises any one or more of: a mapping type applicable to a first number of scheduled intervals; a mapping type applicable to scheduled slots other than a first number of scheduled intervals; an interval offset for a first scheduled interval; a start symbol applicable to one or more scheduled intervals; a transmission length applicable to one or more scheduled intervals; and a flag indicating whether start symbol and length values apply to every scheduled slot or to a subset of the slots.

In some embodiments, codeblock group feedback is configured and activated, and no codeblock group transmission indication field is included in the scheduling message and each of the RV and NDI bit widths are equal to the maximum number of scheduled slots indicated in configuration information signaled to the wireless communication device. The first predetermined table may provide, for the time resource assignment indication in the scheduling message, separate scheduling information for each scheduled interval. The number of scheduled intervals may be indicated by the first predetermined table, for the time resource assignment indication in the scheduling message.

Method 1100 may include receiving a message identifying a subset of the first predetermined table to which the time resource assignment indication in the scheduling message applies. In some embodiments, the scheduling message schedules uplink transmissions and includes an indication of whether the wireless communication device is permitted to use fewer than all of the multiple intervals scheduled by the scheduling message. In other embodiments, the scheduling message schedules uplink transmissions and includes an indication that the wireless communication device is permitted to use only one of the multiple intervals scheduled by the scheduling message.

In some embodiments, the scheduling message includes an indication of a listen-before-talk priority class, wherein the indication is applicable to one or to all of the scheduled intervals.

In other embodiments, the scheduling message includes an indication of an energy detection threshold for listen-before-talk operation, wherein the indication is applicable to one or to all of the scheduled intervals.

Method 1100 may include receiving configuration information specifying a plurality of multi-interval scheduling configurations, each multi-interval scheduling configuration comprising one or more allocation parameters. The scheduling message may indicate one of the plurality of multi-interval scheduling configurations. The scheduling message may indicate different frequency resources for different scheduling intervals.

In some embodiments, a resource assignment indication in the scheduling message maps to a first predetermined table of resource allocations, and a resource allocation in the first predetermined table of resource allocations identified by the resource assignment indication indicates different frequency resources for different scheduling intervals.

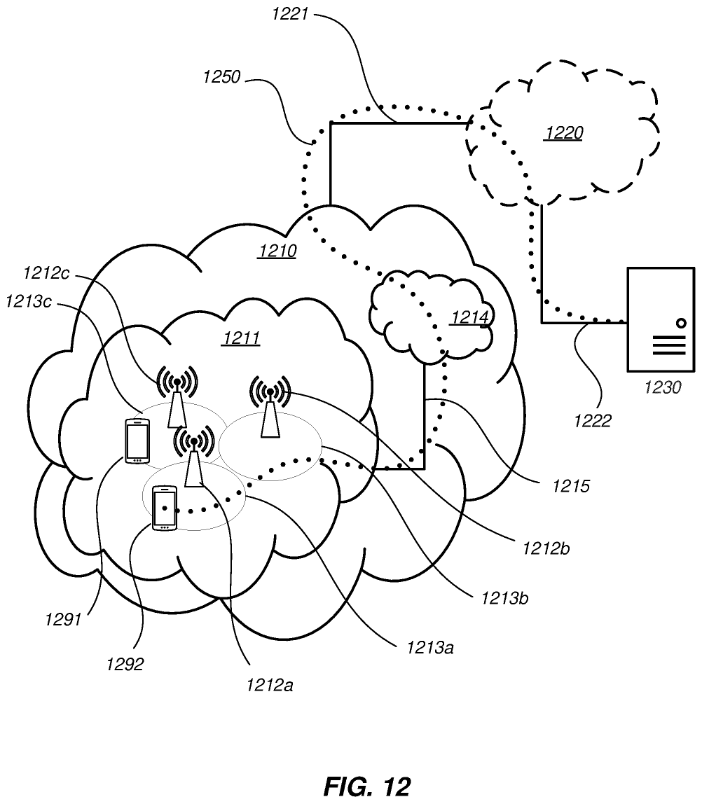

FIG. 12, according to some embodiments, illustrates a communication system that includes a telecommunication network 1210, such as a 3GPP-type cellular network, which comprises an access network 1211, such as a radio access network, and a core network 1214. The access network 1211 comprises a plurality of base stations 1212a, 1212b, 1212c, such as NBs, eNBs, gNBs or other types of wireless access points, each defining a corresponding coverage area 1213a, 1213b, 1213c. Each base station 1212a, 1212b, 1212c is connectable to the core network 1214 over a wired or wireless connection 1215. A first UE 1291 located in coverage area 1213c is configured to wirelessly connect to, or be paged by, the corresponding base station 1212c. A second UE 1292 in coverage area 1213a is wirelessly connectable to the corresponding base station 1212a. While a plurality of UEs 1291, 1292 are illustrated in this example, the disclosed embodiments are equally applicable to a situation where a sole UE is in the coverage area or where a sole UE is connecting to the corresponding base station 1212.

The telecommunication network 1210 is itself connected to a host computer 1230, which may be embodied in the hardware and/or software of a standalone server, a cloud-implemented server, a distributed server or as processing resources in a server farm. The host computer 1230 may be under the ownership or control of a service provider, or may be operated by the service provider or on behalf of the service provider. The connections 1221, 1222 between the telecommunication network 1210 and the host computer 1230 may extend directly from the core network 1214 to the host computer 1230 or may go via an optional intermediate network 1220. The intermediate network 1220 may be one of, or a combination of more than one of, a public, private or hosted network; the intermediate network 1220, if any, may be a backbone network or the Internet; in particular, the intermediate network 1220 may comprise two or more sub-networks (not shown).

The communication system of FIG. 12 as a whole enables connectivity between one of the connected UEs 1291, 1292 and the host computer 1230. The connectivity may be described as an over-the-top (OTT) connection 1250. The host computer 1230 and the connected UEs 1291, 1292 are configured to communicate data and/or signaling via the OTT connection 1250, using the access network 1211, the core network 1214, any intermediate network 1220 and possible further infrastructure (not shown) as intermediaries. The OTT connection 1250 may be transparent in the sense that the participating communication devices through which the OTT connection 1250 passes are unaware of routing of uplink and downlink communications. For example, a base station 1212 may not or need not be informed about the past routing of an incoming downlink communication with data originating from a host computer 1230 to be forwarded (e.g., handed over) to a connected UE 1291. Similarly, the base station 1212 need not be aware of the future routing of an outgoing uplink communication originating from the UE 1291 towards the host computer 1230.

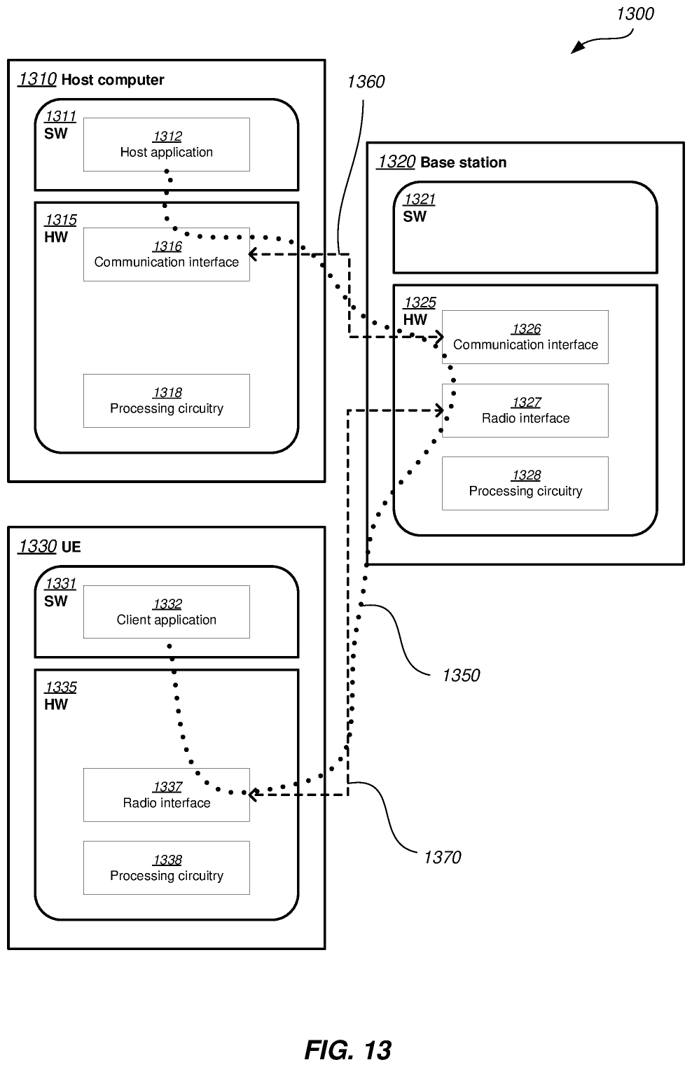

Example implementations, in accordance with an embodiment, of the UE, base station and host computer discussed in the preceding paragraphs will now be described with reference to FIG. 13. In a communication system 1300, a host computer 1310 comprises hardware 1315 including a communication interface 1316 configured to set up and maintain a wired or wireless connection with an interface of a different communication device of the communication system 1300. The host computer 1310 further comprises processing circuitry 1318, which may have storage and/or processing capabilities. In particular, the processing circuitry 1318 may comprise one or more programmable processors, application-specific integrated circuits, field programmable gate arrays or combinations of these (not shown) adapted to execute instructions. The host computer 1310 further comprises software 1311, which is stored in or accessible by the host computer 1310 and executable by the processing circuitry 1318. The software 1311 includes a host application 1312. The host application 1312 may be operable to provide a service to a remote user, such as a UE 1330 connecting via an OTT connection 1350 terminating at the UE 1330 and the host computer 1310. In providing the service to the remote user, the host application 1312 may provide user data which is transmitted using the OTT connection 1350.

The communication system 1300 further includes a base station 1320 provided in a telecommunication system and comprising hardware 1325 enabling it to communicate with the host computer 1310 and with the UE 1330. The hardware 1325 may include a communication interface 1326 for setting up and maintaining a wired or wireless connection with an interface of a different communication device of the communication system 1300, as well as a radio interface 1327 for setting up and maintaining at least a wireless connection 1370 with a UE 1330 located in a coverage area (not shown in FIG. 13) served by the base station 1320. The communication interface 1326 may be configured to facilitate a connection 1360 to the host computer 1310. The connection 1360 may be direct or it may pass through a core network (not shown in FIG. 13) of the telecommunication system and/or through one or more intermediate networks outside the telecommunication system. In the embodiment shown, the hardware 1325 of the base station 1320 further includes processing circuitry 1328, which may comprise one or more programmable processors, application-specific integrated circuits, field programmable gate arrays or combinations of these (not shown) adapted to execute instructions. The base station 1320 further has software 1321 stored internally or accessible via an external connection.

The communication system 1300 further includes the UE 1330 already referred to. Its hardware 1335 may include a radio interface 1337 configured to set up and maintain a wireless connection 1370 with a base station serving a coverage area in which the UE 1330 is currently located. The hardware 1335 of the UE 1330 further includes processing circuitry 1338, which may comprise one or more programmable processors, application-specific integrated circuits, field programmable gate arrays or combinations of these (not shown) adapted to execute instructions. The UE 1330 further comprises software 1331, which is stored in or accessible by the UE 1330 and executable by the processing circuitry 1338. The software 1331 includes a client application 1332. The client application 1332 may be operable to provide a service to a human or non-human user via the UE 1330, with the support of the host computer 1310. In the host computer 1310, an executing host application 1312 may communicate with the executing client application 1332 via the OTT connection 1350 terminating at the UE 1330 and the host computer 1310. In providing the service to the user, the client application 1332 may receive request data from the host application 1312 and provide user data in response to the request data. The OTT connection 1350 may transfer both the request data and the user data. The client application 1332 may interact with the user to generate the user data that it provides.

It is noted that the host computer 1310, base station 1320 and UE 1330 illustrated in FIG. 13 may be identical to the host computer 1330, one of the base stations 1312a, 1312b, 1312c and one of the UEs 1391, 1392 of FIG. 13, respectively. This is to say, the inner workings of these entities may be as shown in FIG. 13 and independently, the surrounding network topology may be that of FIG. 12.

In FIG. 13, the OTT connection 1350 has been drawn abstractly to illustrate the communication between the host computer 1310 and the use equipment 1330 via the base station 1320, without explicit reference to any intermediary devices and the precise routing of messages via these devices. Network infrastructure may determine the routing, which it may be configured to hide from the UE 1330 or from the service provider operating the host computer 1310, or both. While the OTT connection 1350 is active, the network infrastructure may further take decisions by which it dynamically changes the routing (e.g., on the basis of load balancing consideration or reconfiguration of the network).

The wireless connection 1370 between the UE 1330 and the base station 1320 is in accordance with the teachings of the embodiments described throughout this disclosure, such as provided by nodes such as a wireless device and relay node 30, along with the corresponding method 800. The embodiments described herein provide a DCI design that schedules both single or multiple PUSCHs using single DCI. Advantages include reducing overhead on PDCCH by sending scheduling information for multiple slots using one grant, enabling efficient UL scheduling and transmission when multiple starting/ending positions is supported. Another advantage is enabling flexibility in scheduling the multiple slots. The teachings of these embodiments may improve the reliability, connections, data rate, capacity, latency and/or power consumption for the network and UE 1330 using the OTT connection 1350.

A measurement procedure may be provided for the purpose of monitoring data rate, latency and other factors on which the one or more embodiments improve. There may further be an optional network functionality for reconfiguring the OTT connection 1350 between the host computer 1310 and UE 1330, in response to variations in the measurement results. The measurement procedure and/or the network functionality for reconfiguring the OTT connection 1350 may be implemented in the software 1311 of the host computer 1310 or in the software 1331 of the UE 1330, or both. In embodiments, sensors (not shown) may be deployed in or in association with communication devices through which the OTT connection 1350 passes; the sensors may participate in the measurement procedure by supplying values of the monitored quantities exemplified above, or supplying values of other physical quantities from which software 1311, 1331 may compute or estimate the monitored quantities. The reconfiguring of the OTT connection 1350 may include message format, retransmission settings, preferred routing etc.; the reconfiguring need not affect the base station 1320, and it may be unknown or imperceptible to the base station 1320. Such procedures and functionalities may be known and practiced in the art. In certain embodiments, measurements may involve proprietary UE signaling facilitating the host computer's 1310 measurements of throughput, propagation times, latency and the like. The measurements may be implemented in that the software 1311, 1331 causes messages to be transmitted, in particular empty or ‘dummy’ messages, using the OTT connection 1350 while it monitors propagation times, errors etc.

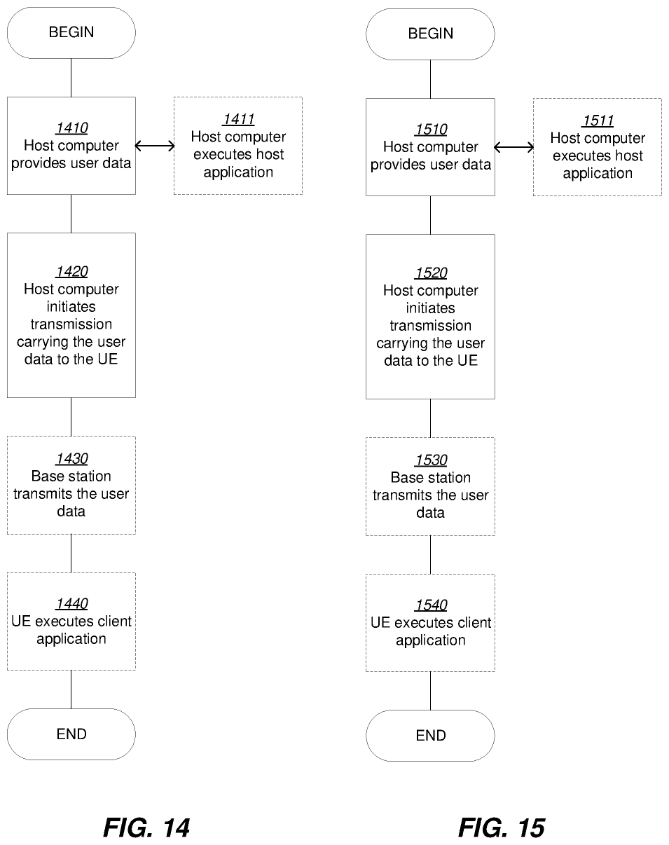

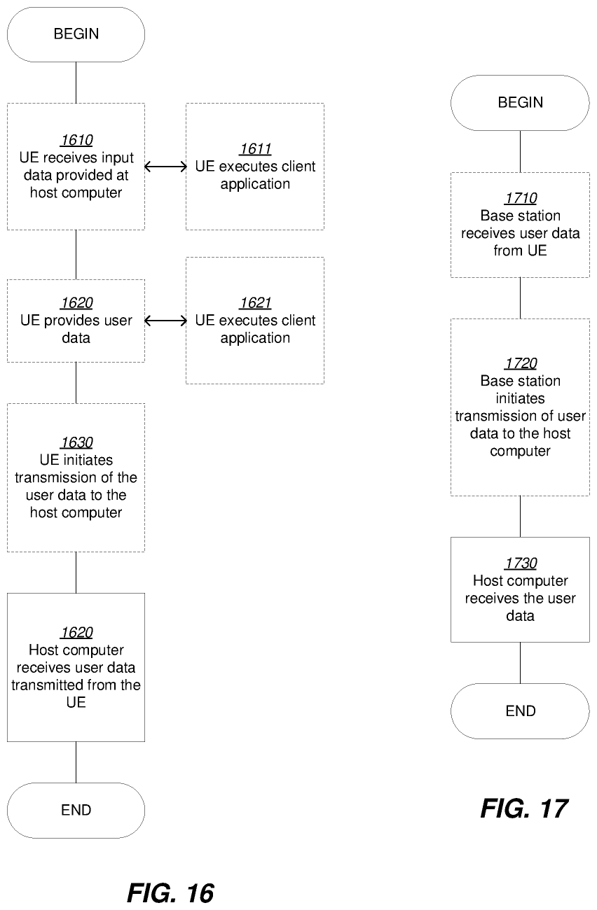

FIG. 14 is a flowchart illustrating a method implemented in a communication system, in accordance with one embodiment. The communication system includes a host computer, a base station and a UE which may be those described with reference to FIGS. 12 and 13. For simplicity of the present disclosure, only drawing references to FIG. 14 will be included in this section. In a first step 1410 of the method, the host computer provides user data. In an optional substep 1411 of the first step 1410, the host computer provides the user data by executing a host application. In a second step 1420, the host computer initiates a transmission carrying the user data to the UE. In an optional third step 1430, the base station transmits to the UE the user data which was carried in the transmission that the host computer initiated, in accordance with the teachings of the embodiments described throughout this disclosure. In an optional fourth step 1440, the UE executes a client application associated with the host application executed by the host computer.

FIG. 15 is a flowchart illustrating a method implemented in a communication system, in accordance with one embodiment. The communication system includes a host computer, a base station and a UE which may be those described with reference to FIGS. 12 and 13. For simplicity of the present disclosure, only drawing references to FIG. 15 will be included in this section. In a first step 1510 of the method, the host computer provides user data. In an optional substep (not shown) the host computer provides the user data by executing a host application. In a second step 1520, the host computer initiates a transmission carrying the user data to the UE. The transmission may pass via the base station, in accordance with the teachings of the embodiments described throughout this disclosure. In an optional third step 1530, the UE receives the user data carried in the transmission.

FIG. 16 is a flowchart illustrating a method implemented in a communication system, in accordance with one embodiment. The communication system includes a host computer, a base station and a UE which may be those described with reference to FIGS. 12 and 13. For simplicity of the present disclosure, only drawing references to FIG. 16 will be included in this section. In an optional first step 1610 of the method, the UE receives input data provided by the host computer. Additionally, or alternatively, in an optional second step 1620, the UE provides user data. In an optional substep 1621 of the second step 1620, the UE provides the user data by executing a client application. In a further optional substep 1611 of the first step 1610, the UE executes a client application which provides the user data in reaction to the received input data provided by the host computer. In providing the user data, the executed client application may further consider user input received from the user. Regardless of the specific manner in which the user data was provided, the UE initiates, in an optional third substep 1630, transmission of the user data to the host computer. In a fourth step 1640 of the method, the host computer receives the user data transmitted from the UE, in accordance with the teachings of the embodiments described throughout this disclosure.

FIG. 17 is a flowchart illustrating a method implemented in a communication system, in accordance with one embodiment. The communication system includes a host computer, a base station and a UE which may be those described with reference to FIGS. 12 and 13. For simplicity of the present disclosure, only drawing references to FIG. 17 will be included in this section. In an optional first step 1710 of the method, in accordance with the teachings of the embodiments described throughout this disclosure, the base station receives user data from the UE. In an optional second step 1720, the base station initiates transmission of the received user data to the host computer. In a third step 1730, the host computer receives the user data carried in the transmission initiated by the base station.

As discussed in detail above, the techniques described herein, e.g., as illustrated in the process flow diagram of FIGS. 7-8 and 10-11, may be implemented, in whole or in part, using computer program instructions executed by one or more processors. It will be appreciated that a functional implementation of these techniques may be represented in terms of functional modules, where each functional module corresponds to a functional unit of software executing in an appropriate processor or to a functional digital hardware circuit, or some combination of both.

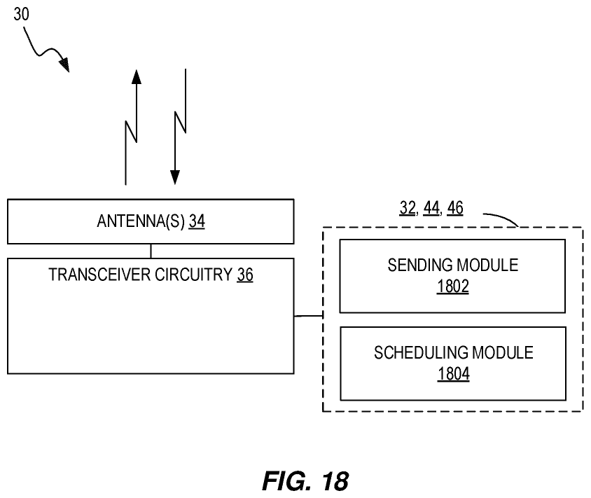

FIG. 18 illustrates an example functional module or circuit architecture for a wireless device 50 for multi-interval scheduling downlink or uplink transmissions to or from a wireless communication device. The functional implementation includes a sending module 1802 for sending, to the wireless device, configuration information indicating one or both of a maximum number of scheduling intervals that can be scheduled with a single scheduling message and a time-domain resource allocation data structure to be used when multi-interval scheduling is in use.

Another functional implementation in wireless device 50 includes a scheduling module 1804 for scheduling one or more downlink or uplink transmissions to or from the wireless communication device, using a single scheduling message scheduling a transmission in each of multiple scheduling intervals, where the number of scheduled intervals is indicated in the scheduling message by a dedicated field in or by a time resource assignment indication that implicitly or explicitly indicates the number of scheduled intervals.

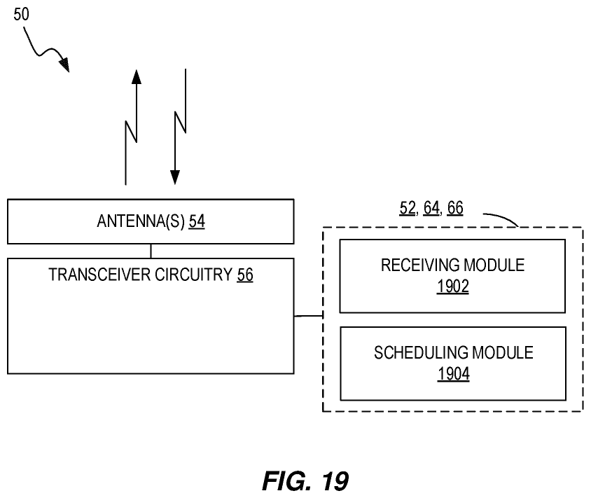

FIG. 19 illustrates an example functional module or circuit architecture for a wireless device 50 for multi-interval scheduling of downlink or uplink transmissions to or from the wireless communication device. The functional implementation includes a receiving module 1902 for receiving, from a network node in the wireless communication system, configuration information indicating one or both of a maximum number of scheduling intervals that can be scheduled with a single scheduling message and a time-domain resource allocation data structure to be used when multi-interval scheduling is in use.

Another implementation includes a scheduling module 1904 for receiving scheduling information for one or more downlink or uplink transmissions to or from the wireless communication device, in a single scheduling message scheduling a transmission in each of multiple scheduling intervals, where the number of scheduled intervals is indicated in the scheduling message by a dedicated field in or by a time resource assignment indication that implicitly or explicitly indicates the number of scheduled intervals.

### EXAMPLE EMBODIMENTS

Example embodiments can include, but are not limited to, the following enumerated examples:

1. A method, in a network node of a wireless communication system, for multi-interval scheduling downlink or uplink transmissions to or from a wireless communication device, the method comprising:
sending, to the wireless device, configuration information indicating one or both of a maximum number of scheduling intervals that can be scheduled with a single scheduling message and a time-domain resource allocation data structure to be used when multi-interval scheduling is in use.

2. The method of example embodiment 1, wherein the scheduling intervals are slots or mini-slots.

3. The method of example embodiment 1 or 2, further comprising:
scheduling one or more downlink or uplink transmissions to or from the wireless communication device, in accordance with the configuration information.

4. The method of example embodiment 3, wherein said scheduling is performed using a single scheduling message scheduling a transmission in each of multiple scheduling intervals.

5. A method, in a network node of a wireless communication system, for multi-interval scheduling downlink or uplink transmissions to or from a wireless communication device, the method comprising:
scheduling one or more downlink or uplink transmissions to or from the wireless communication device, using a single scheduling message scheduling a transmission in each of multiple scheduling intervals,
wherein the number of scheduled intervals is indicated in the scheduling message by a dedicated field in or by a time resource assignment indication that implicitly or explicitly indicates the number of scheduled intervals.

6. The method of example embodiment 5, wherein the scheduling intervals are slots or mini-slots.

7. The method of example embodiment 5 or 6, further comprising:
sending one or more downlink transmissions to the wireless device or receiving one or more uplink transmissions from the wireless communication device, in accordance with the scheduling message.

8. The method of any of example embodiments 5-7, wherein the number of scheduled intervals is indicated by a dedicated field in the scheduling message, and wherein a time resource assignment indication in the scheduling message maps to a first predetermined table of time resource allocations, wherein the first predetermined table of time resource allocations differs from a second predetermined table of time resource allocations that is applicable when the number of scheduled intervals is 1.

9. The method of example embodiment 8, wherein each of one or more entries in the first predetermined table comprises any one or more of:
a mapping type applicable to a first number of scheduled intervals;
a mapping type applicable to scheduled slots other than a first number of scheduled intervals;
an interval offset for a first scheduled interval;
a start symbol applicable to one or more scheduled intervals;
a transmission length applicable to one or more scheduled intervals; and
a flag indicating whether start symbol and length values apply to every scheduled slot or to a subset of the slots.

10. The method of any of example embodiments 5-9, wherein codeblock group feedback is configured and activated, and wherein:
no codeblock group transmission indication field is included in the scheduling message and each of the RV and NDI bit widths are equal to the maximum number of scheduled slots indicated in configuration information signaled to the wireless communication device.

11. The method of example embodiments 5-10, wherein the first predetermined table provides, for the time resource assignment indication in the scheduling message, separate scheduling information for each scheduled interval.

12. The method of example embodiment 11, wherein the number of scheduled intervals is indicated by the first predetermined table, for the time resource assignment indication in the scheduling message.

13. The method of any of example embodiments 5-12, wherein the method further comprises sending a message to the wireless device identifying a subset of the first predetermined table to which the time resource assignment indication in the scheduling message applies.

14. The method of any of example embodiments 5-13, wherein the scheduling message schedules uplink transmissions and includes an indication of whether the wireless communication device is permitted to use fewer than all of the multiple intervals scheduled by the scheduling message.

15. The method of any of example embodiments 5-13, wherein the scheduling message schedules uplink transmissions and includes an indication that the wireless communication device is permitted to use only one of the multiple intervals scheduled by the scheduling message.

16. The method of any of example embodiments 5-15, wherein the scheduling message includes an indication of a listen-before-talk priority class, wherein the indication is applicable to one or to all of the scheduled intervals.

17. The method of any of example embodiments 5-16, wherein the scheduling message includes an indication of an energy detection threshold for listen-before-talk operation, wherein the indication is applicable to one or to all of the scheduled intervals.

18. The method of any of example embodiments 5-7, wherein the method comprises sending, to the wireless communication device, configuration information specifying a plurality of multi-interval scheduling configurations, each multi-interval scheduling configuration comprising one or more allocation parameters, and wherein the scheduling message indicates one of the plurality of multi-interval scheduling configurations.

19. The method of any of example embodiments 5-18, wherein the scheduling message indicates different frequency resources for different scheduling intervals.

20. The method of any of example embodiments 5-7, wherein a resource assignment indication in the scheduling message maps to a first predetermined table of resource allocations, and wherein a resource allocation in the first predetermined table of resource allocations identified by the resource assignment indication indicates different frequency resources for different scheduling intervals.

21. A method, in a wireless communication device operating in a wireless communication system, for multi-interval scheduling of downlink or uplink transmissions to or from the wireless communication device, the method comprising:
receiving, from a network node in the wireless communication system, configuration information indicating one or both of a maximum number of scheduling intervals that can be scheduled with a single scheduling message and a time-domain resource allocation data structure to be used when multi-interval scheduling is in use.

22. The method of example embodiment 21, wherein the scheduling intervals are slots or mini-slots.

23. The method of example embodiment 21 or 22, further comprising:
receiving scheduling information for one or more downlink or uplink transmissions to or from the wireless communication device, in accordance with the configuration information.

24. The method of example embodiment 23, wherein said scheduling information is received in a single scheduling message scheduling a transmission in each of multiple scheduling intervals.

25. A method, in a wireless communication device operating in a wireless communication system, for multi-interval scheduling of downlink or uplink transmissions to or from the wireless communication device, the method comprising:
receiving scheduling information for one or more downlink or uplink transmissions to or from the wireless communication device, in a single scheduling message scheduling a transmission in each of multiple scheduling intervals,
wherein the number of scheduled intervals is indicated in the scheduling message by a dedicated field in or by a time resource assignment indication that implicitly or explicitly indicates the number of scheduled intervals.

26. The method of example embodiment 25, wherein the scheduling intervals are slots or mini-slots.

27. The method of example embodiment 25 or 26, further comprising:
sending one or more uplink transmissions or receiving one or more downlink transmissions, in accordance with the scheduling message.

28. The method of any of example embodiments 25-27, wherein the number of scheduled intervals is indicated by a dedicated field in the scheduling message, and wherein a time resource assignment indication in the scheduling message maps to a first predetermined table of time resource allocations, wherein the first predetermined table of time resource allocations differs from a second predetermined table of time resource allocations that is applicable when the number of scheduled intervals is 1.

29. The method of example embodiment 28, wherein each of one or more entries in the first predetermined table comprises any one or more of:
a mapping type applicable to a first number of scheduled intervals;
a mapping type applicable to scheduled slots other than a first number of scheduled intervals;
an interval offset for a first scheduled interval;
a start symbol applicable to one or more scheduled intervals;
a transmission length applicable to one or more scheduled intervals; and
a flag indicating whether start symbol and length values apply to every scheduled slot or to a subset of the slots.

30. The method of any of example embodiments 25-29, wherein codeblock group feedback is configured and activated, and wherein:
no codeblock group transmission indication field is included in the scheduling message and each of the RV and NDI bit widths are equal to the maximum number of scheduled slots indicated in configuration information signaled to the wireless communication device.

31. The method of example embodiments 25-30, wherein the first predetermined table provides, for the time resource assignment indication in the scheduling message, separate scheduling information for each scheduled interval.

32. The method of example embodiment 31, wherein the number of scheduled intervals is indicated by the first predetermined table, for the time resource assignment indication in the scheduling message.

33. The method of any of example embodiments 25-32, wherein the method further comprises receiving a message identifying a subset of the first predetermined table to which the time resource assignment indication in the scheduling message applies.

34. The method of any of example embodiments 25-33, wherein the scheduling message schedules uplink transmissions and includes an indication of whether the wireless communication device is permitted to use fewer than all of the multiple intervals scheduled by the scheduling message.

35. The method of any of example embodiments 25-33, wherein the scheduling message schedules uplink transmissions and includes an indication that the wireless communication device is permitted to use only one of the multiple intervals scheduled by the scheduling message.

36. The method of any of example embodiments 25-35, wherein the scheduling message includes an indication of a listen-before-talk priority class, wherein the indication is applicable to one or to all of the scheduled intervals.

37. The method of any of example embodiments 25-36, wherein the scheduling message includes an indication of an energy detection threshold for listen-before-talk operation, wherein the indication is applicable to one or to all of the scheduled intervals.

38. The method of any of example embodiments 25-27, wherein the method comprises receiving configuration information specifying a plurality of multi-interval scheduling configurations, each multi-interval scheduling configuration comprising one or more allocation parameters, and wherein the scheduling message indicates one of the plurality of multi-interval scheduling configurations.

39. The method of any of example embodiments 25-38, wherein the scheduling message indicates different frequency resources for different scheduling intervals.

40. The method of any of example embodiments 25-27, wherein a resource assignment indication in the scheduling message maps to a first predetermined table of resource allocations, and wherein a resource allocation in the first predetermined table of resource allocations identified by the resource assignment indication indicates different frequency resources for different scheduling intervals.

41. A network node adapted to perform a method according to any of example embodiments 1-20.

42. A network node comprising transceiver circuitry and processing circuitry operatively associated with the transceiver circuitry and configured to perform a method according to any of example embodiments 1-20.

43. A wireless device adapted to perform a method according to any of example embodiments 21-40.

44. A wireless device comprising transceiver circuitry and processing circuitry operatively associated with the transceiver circuitry and configured to perform a method according to any of example embodiments 21-40.

45. A computer program comprising instructions that, when executed on at least one processing circuit, cause the at least one processing circuit to carry out a method according to any one of example embodiments 1-40.

46. A carrier containing the computer program of example embodiment 45, wherein the carrier is one of an electronic signal, optical signal, radio signal, or computer readable storage medium.

A1. A communication system including a host computer comprising:
processing circuitry configured to provide user data; and
a communication interface configured to forward the user data to a cellular network for transmission to a user equipment (UE), wherein the cellular network comprises a base station having a radio interface and processing circuitry, the base station's processing circuitry configured to perform any of the operations comprising embodiments 1-20.

A2. The communication system of the previous embodiment further including the base station.

A3. The communication system of the previous two embodiments, further including the UE, wherein the UE is configured to communicate with the base station.

A4. The communication system of the previous three embodiments, wherein:
the processing circuitry of the host computer is configured to execute a host application, thereby providing the user data; and
the UE comprises processing circuitry configured to execute a client application associated with the host application.

A5. A method implemented in a communication system including a host computer, a base station and a user equipment (UE), the method comprising:
at the host computer, providing user data; and
at the host computer, initiating a transmission carrying the user data to the UE via a cellular network comprising the base station, wherein the base station performs any of the steps of any of embodiments 1-20.

A6. The method of the previous embodiment, further comprising, at the base station, transmitting the user data.

A7. The method of the previous 2 embodiments, wherein the user data is provided at the host computer by executing a host application, the method further comprising, at the UE, executing a client application associated with the host application.

A8. A user equipment (UE) configured to communicate with a base station, the UE comprising a radio interface and processing circuitry configured to perform any of the previous 3 embodiments.

A9. A communication system including a host computer comprising:
processing circuitry configured to provide user data; and
a communication interface configured to forward user data to a cellular network for transmission to a user equipment (UE),
wherein the UE comprises a radio interface and processing circuitry, the UE's components configured to perform any of the steps of any of embodiments 21-40.

A10. The communication system of the previous embodiment, wherein the cellular network further includes a base station configured to communicate with the UE.

A11. The communication system of the previous 2 embodiments, wherein:
the processing circuitry of the host computer is configured to execute a host application, thereby providing the user data; and
the UE's processing circuitry is configured to execute a client application associated with the host application.

A12. A method implemented in a communication system including a host computer, a base station and a user equipment (UE), the method comprising:
at the host computer, providing user data; and
at the host computer, initiating a transmission carrying the user data to the UE via a cellular network comprising the base station, wherein the UE performs any of the steps of any of embodiments 21-40.

A13. The method of the previous embodiment, further comprising at the UE, receiving the user data from the base station.

A14. A communication system including a host computer comprising:
communication interface configured to receive user data originating from a transmission from a user equipment (UE) to a base station,
wherein the UE comprises a radio interface and processing circuitry, the UE's processing circuitry configured to perform any of the steps of any of embodiments 21-40.

A15. The communication system of the previous embodiment, further including the UE.

A16. The communication system of the previous 2 embodiments, further including the base station, wherein the base station comprises a radio interface configured to communicate with the UE and a communication interface configured to forward to the host computer the user data carried by a transmission from the UE to the base station.

A17. The communication system of the previous 3 embodiments, wherein:
the processing circuitry of the host computer is configured to execute a host application; and the UE's processing circuitry is configured to execute a client application associated with the host application, thereby providing the user data.

A18. The communication system of the previous 4 embodiments, wherein:
the processing circuitry of the host computer is configured to execute a host application, thereby providing request data; and
the UE's processing circuitry is configured to execute a client application associated with the host application, thereby providing the user data in response to the request data.

A19. A method implemented in a communication system including a host computer, a base station and a user equipment (UE), the method comprising:
at the host computer, receiving user data transmitted to the base station from the UE, wherein the UE performs any of the steps of any of embodiments 21-40.

A20. The method of the previous embodiment, further comprising, at the UE, providing the user data to the base station.

A21. The method of the previous 2 embodiments, further comprising:
at the UE, executing a client application, thereby providing the user data to be transmitted; and at the host computer, executing a host application associated with the client application.

A22. The method of the previous 3 embodiments, further comprising:
at the UE, executing a client application; and at the UE, receiving input data to the client application, the input data being provided at the host computer by executing a host application associated with the client application, wherein the user data to be transmitted is provided by the client application in response to the input data.

A23. A communication system including a host computer comprising a communication interface configured to receive user data originating from a transmission from a User equipment (UE) to a base station, the base station comprising a radio interface and processing circuitry configured to communicate with the base station and cooperatively perform operations of any of embodiments 1-20.

A24. The communication system of the previous embodiment further including the base station.

A25. The communication system of the previous two embodiments, further including the UE, wherein the UE is configured to communicate with the base station.

A26. The communication system of the previous three embodiments, wherein:
the processing circuitry of the host computer is configured to execute a host application; and
the UE is further configured to execute a client application associated with the host application, thereby providing the user data to be received by the host computer.

A27. A method implemented in a communication system including a host computer, a base station and a user equipment (UE), the method comprising:
at the host computer, receiving, from the base station, user data originating from a transmission which the base station has received from the UE, wherein the UE performs any of the steps of any of embodiments 21-40.

A28. The method of the previous embodiment, further comprising at the base station, receiving the user data from the UE.

A29. The method of the previous 2 embodiments, further comprising at the base station, initiating a transmission of the received user data to the host computer.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the examples of embodiments are intended to cover all such modifications, enhancements, and other embodiments, which fall within the spirit and scope of present inventive concepts. Thus, to the maximum extent allowed by law, the scope of present inventive concepts is to be determined by the broadest permissible interpretation of the present disclosure including the examples of embodiments and their equivalents, and shall not be restricted or limited by the foregoing detailed description.

1-48. (canceled)

49. A method, in a network node of a wireless communication system, for downlink or uplink transmissions to or from a wireless communication device, the method comprising:
scheduling multiple downlink or uplink transmissions to or from the wireless communication device, using a single scheduling message,
wherein a number of scheduled intervals is indicated in the scheduling message by a dedicated field,
wherein a time resource assignment indication in the scheduling message maps to a predetermined table of time resource allocations; and
wherein the predetermined table of time resource allocations comprises:
an interval offset for a first scheduled interval;
a start symbol applicable to one or more scheduled intervals; and
a transmission length applicable to one or more scheduled intervals.

50. The method of claim 49, wherein the scheduling intervals are slots or mini-slots.

51. The method of claim 49, further comprising:
sending one or more downlink transmissions to the wireless device or receiving one or more uplink transmissions from the wireless communication device, in accordance with the scheduling message.

52. The method of claim 49, wherein each of one or more entries in the predetermined table comprises any one or more of:
a mapping type applicable to a first number of scheduled intervals;
a mapping type applicable to scheduled intervals other than a first number of scheduled intervals; and
a flag indicating whether, (a) the start symbol and the transmission length apply to every scheduled interval, or (b) the start symbol applies to a first scheduled interval of multiple scheduled intervals with no gaps in between and the transmission length is a transmission length for the last scheduled interval of the multiple scheduled intervals, with all scheduled intervals between the first scheduled interval and the last scheduled interval having a transmission length equal to a scheduling interval length.

53. The method of claim 49, wherein the single scheduling message schedules a transmission in each of multiple scheduling intervals, wherein codeblock group feedback is configured and activated, and wherein:
no codeblock group transmission indication field is included in the scheduling message and each of the RV and NDI bit widths are equal to the maximum number of scheduled
slots indicated in configuration information signaled to the wireless communication device.

54. The method of claim 49, wherein the scheduling message schedules uplink transmissions and includes an indication of whether the wireless communication device is permitted to use fewer than all of the multiple intervals scheduled by the scheduling message.

55. The method of claim 49, wherein the scheduling message schedules uplink transmissions and includes an indication that the wireless communication device is permitted to use only one of the multiple intervals scheduled by the scheduling message.

56. The method of claim 49, wherein the scheduling message includes an indication of a listen-before-talk priority class, wherein the indication is applicable to one or to all of the scheduled intervals.

57. The method of claim 49, wherein the scheduling message includes an indication of an energy detection threshold for listen-before-talk operation, wherein the indication is applicable to one or to all of the scheduled intervals.

58. The method of claim 49, wherein the method comprises sending, to the wireless communication device, configuration information specifying a plurality of multi-interval scheduling configurations, each multi-interval scheduling configuration comprising one or more allocation parameters, and wherein the scheduling message indicates one of the plurality of multi-interval scheduling configurations.

59. The method of claim 49, wherein the scheduling message indicates different frequency resources for different scheduling intervals.

60. A method, in a wireless communication device operating in a wireless communication system, for scheduling of downlink or uplink transmissions to or from the wireless communication device, the method comprising:
receiving scheduling information for multiple downlink or uplink transmissions to or from the wireless communication device, in a single scheduling message;
wherein the number of scheduled intervals is indicated in the scheduling message by a dedicated field in a time resource assignment indication that implicitly or explicitly indicates the number of scheduled intervals;
wherein the time resource assignment indication in the scheduling message maps to a predetermined table of time resource allocations; and
wherein the predetermined table of time resource allocations comprises:
an interval offset for a first scheduled interval;
a start symbol applicable to one or more scheduled intervals; and
a transmission length applicable to one or more scheduled intervals.

61. The method of claim 60, wherein the scheduling intervals are slots or mini-slots.

62. The method of claim 60, further comprising:
sending one or more uplink transmissions or receiving one or more downlink transmissions, in accordance with the scheduling message.

63. The method of claim 60, wherein each of one or more entries in the predetermined table comprises any one or more of:
a mapping type applicable to a first number of scheduled intervals;
a mapping type applicable to scheduled intervals other than a first number of scheduled intervals; and
a flag indicating whether, (a) the start symbol and the transmission length apply to every scheduled interval, such that there are gaps between the scheduled intervals, or (b) the start symbol applies to a first scheduled interval of multiple scheduled intervals with no gaps in between and the transmission length is a transmission length for the last scheduled interval of the multiple scheduled intervals, with all scheduled intervals between the first scheduled interval and the last scheduled interval having a transmission length equal to a scheduling interval length.

64. The method of claim 60, wherein the single scheduling message schedules a transmission in each of multiple scheduling intervals, wherein codeblock group feedback is configured and activated, and wherein:
no codeblock group transmission indication field is included in the scheduling message and each of the RV and NDI bit widths are equal to the maximum number of scheduled slots indicated in configuration information signaled to the wireless communication device.

65. The method of claim 60, wherein the scheduling message schedules uplink transmissions and includes an indication of whether the wireless communication device is permitted to use fewer than all of the multiple intervals scheduled by the scheduling message.

66. The method of claim 60, wherein the scheduling message schedules uplink transmissions and includes an indication that the wireless communication device is permitted to use only one of the multiple intervals scheduled by the scheduling message.

67. The method of claim 60, wherein the scheduling message includes an indication of a listen-before-talk priority class, wherein the indication is applicable to one or to all of the scheduled intervals.

68. The method of claim 60, wherein the scheduling message includes an indication of an energy detection threshold for listen-before-talk operation, wherein the indication is applicable to one or to all of the scheduled intervals.

69. The method of claim 60, wherein the method comprises receiving configuration information specifying a plurality of multi-interval scheduling configurations, each multi-interval scheduling configuration comprising one or more allocation parameters, and wherein the scheduling message indicates one of the plurality of multi-interval scheduling configurations.

70. The method of claim 60, wherein the scheduling message indicates different frequency resources for different scheduling intervals.

71. A network node comprising transceiver circuitry and processing circuitry operatively associated with the transceiver circuitry and configured to perform a method according to claim 49.

72. A wireless device comprising transceiver circuitry and processing circuitry operatively associated with the transceiver circuitry and configured to perform a method according to claim 60.
